(19) United States
(12) Patent Application Publication
(10) Pub. No.: US 2026/0205977 A1
(43) Pub. Date: Jul. 16, 2026

(54) ELECTRONIC DEVICE, METHOD, AND RECORDING MEDIUM FOR REMOTE CONTROL

(71) Applicant: SAMSUNG ELECTRONICS CO., LTD., Suwon-si (KR)

(72) Inventors: Hojeen JEE, Suwon-si (KR); Jangwoo LEE, Suwon-si (KR); Jongha WOO, Suwon-si (KR); Chinok KO, Suwon-si (KR)

(73) Assignee: SAMSUNG ELECTRONICS CO., LTD., Suwon-si (KR)

(21) Appl. No.: 19/462,727

(22) Filed: Jan. 28, 2026

Related U.S. Application Data
(63) Continuation of application No. PCT/KR2026/000635, filed on Jan. 12, 2026.

(30) Foreign Application Priority Data
Jan. 10, 2025 (KR) 10-2025-0003896

(51) Int. Cl. H04W 60/00; H04W 12/037

(52) U.S. Cl. CPC H04W 60/00; H04W 12/037

(57) ABSTRACT

An electronic device including a communication circuit; memory including one or more storage media storing instructions; and at least one processor including a processing circuit, wherein based on the instructions being executed individually or collectively by the at least one processor, the electronic device is configured to: perform a registration procedure corresponding to obtaining control authority for a first device based on characteristic information about the first device, and control the communication circuit to transmit, to a second device, data for obtaining the control authority for the first device.

### CROSS-REFERENCE TO RELATED APPLICATIONS

This application is a continuation of International Application No. PCT/KR2026/000635 designating the United States, filed on Jan. 12, 2026, in the Korean Ministry of Intellectual Property Receiving Office, and claiming priority from Korean Patent Application No. 10-2025-0003896 filed on Jan. 10, 2025 in the Ministry of Intellectual Property, the disclosure of which is incorporated by reference herein in their entireties.

### BACKGROUND

### 1. Field

The disclosure relates to an electronic device, method, and recording medium for remote control.

### 2. Background of Related Art

Generally, a display device such as a television may provide a function of displaying an image that a user wants to view. The user may view desired content through the display device. The display device may output selected content by the user through a display of the display device. The display device may determine, among content transmitted by a broadcasting station or provided by a content providing server, content to output based on the user's selection.

The display device may be controlled remotely by a control device such as a remote control. A control device other than a traditional remote control is being developed. For example, a personal portable terminal such as a smartphone may be used as a control device.

With the development of the multimedia industry, the types and/or functions of services provided by display devices are increasing at a rapid pace. In this case, since functions to be controlled using a control device may increase, there is a need to prepare a scheme that enables more control operations using limited operation means.

The above-described information may be provided as related art for the purpose of helping understanding of the disclosure. None of the content may be claimed as prior art related to the disclosure or used to determine prior art.

### SUMMARY

According to an aspect of the disclosure, an electronic device, including: a communication circuit; memory including one or more storage media storing instructions; and at least one processor including a processing circuit, wherein based on the instructions being executed individually or collectively by the at least one processor, the electronic device is configured to: perform a registration procedure corresponding to obtaining control authority for a first device based on characteristic information about the first device, and control the communication circuit to transmit, to a second device, data for obtaining the control authority for the first device.

According to an aspect of the disclosure, a method of operating an electronic device includes performing a registration procedure corresponding to obtaining control authority for a first device based on characteristic information about the first device; and controlling a communication circuit of the electronic device to transmit, to a second device, data for obtaining the control authority for the first device.

According to an aspect of the disclosure, a non-transitory recording medium storing computer-readable instructions, wherein the instructions, based on being executed by at least a portion of at least one processor included in an electronic device, cause the electronic device to perform at least one operation that includes: performing a registration procedure corresponding to obtaining control authority for a first device based on characteristic information about the first device; and controlling a communication circuit of an electronic device to transmit, to a second device, data for obtaining the control authority for the first device to a second device.

For example, an electronic device may include a communication circuit. The electronic device may comprise a memory including one or more storage media storing instructions. The electronic device may include at least one processor including a processing circuit. The instructions may, based on being executed individually or collectively by the at least one processor, cause the electronic device to perform at least one operation. The at least one operation may include performing a registration procedure for obtaining control authority for a remote control target device. The at least one operation may include remotely controlling a power state of the remote control target device in a sleep state based on the control authority. The at least one operation may include remotely controlling the remote control target device in an idle state or an active state based on the control authority. The at least one operation may include sharing control authority with another electronic device based on the control authority. Performing the registration procedure may include obtaining identification information of the remote control target device, a first temporary key having a validity time, or a wakeup key. Performing the registration procedure may include connecting the remote control target device corresponding to the obtained identification information using the obtained first temporary key. Performing the registration procedure may include obtaining a session key to be used for connection authority verification for the remote control target device based on connection to the remote control target device being successful. Performing the registration procedure may include receiving an encrypted base key from the remote control target device. Performing the registration procedure may include decrypting the encrypted base key using the obtained session key to obtain the base key.

For example, the remote control target device may include a communication circuit. The remote control target device may include a memory including one or more storage media storing instructions. The remote control target device may include at least one processor including a processing circuit. The instructions may, based on being executed individually or collectively by the at least one processor, cause the remote control target device to perform at least one operation. The at least one operation may include performing a registration procedure for granting control authority to a first electronic device. The at least one operation may include controlling a power state in response to a request from the first electronic device to which the control authority has been granted. The at least one operation may include performing remote control according to a request from the first electronic device to which the control authority has been granted. Performing the registration procedure may include providing identification information, a first temporary key having a validity time, or a wakeup key to the first electronic device. Performing the registration procedure may include connecting the first electronic device using the first temporary key. Performing the registration procedure may include obtaining a first session key to be used for connection authority verification for the first electronic device based on connection to the first electronic device being successful. Performing the registration procedure may include transmitting a base key encrypted by the obtained first session key to the first electronic device.

For example, an electronic device may include a communication circuit. The electronic device may include a memory including one or more storage media storing instructions. The electronic device may include at least one processor including a processing circuit. The instructions may, based on being executed individually or collectively by the at least one processor, cause the electronic device to perform at least one operation. The at least one operation may include receiving control authority for a remote control target device shared from another electronic device that has obtained control authority for the remote control target device. The at least one operation may include remotely controlling a power state of the remote control target device in a sleep state based on the shared control authority. The at least one operation may include remotely controlling the remote control target device in an idle state or an active state based on the shared control authority. Receiving the control authority shared may include obtaining identification information of the remote control target device, a wakeup key, and a first temporary key having a validity time provided by the other electronic device in response to a control authority sharing request. The first temporary key may be generated by encrypting information about current time with a base key.

### BRIEF DESCRIPTION OF DRAWINGS

The same or similar reference denotations may be used to refer to the same or similar elements throughout the specification and the drawings.

FIG. 1 is a view illustrating a configuration of a remote control system capable of performing remote control based on a network environment according to various embodiments.

FIG. 2 is a view illustrating a procedure for registering an electronic device for remote control of a remote control target device in the remote control system according to one or more embodiments.

FIG. 3 is a view illustrating a procedure in which an electronic device controls a power state of a remote control target device or remotely controls substantial operations in the remote control system according to an embodiment.

FIG. 4 is a view illustrating a procedure in which a first electronic device shares control authority for remotely controlling a remote control target device with a second electronic device in the remote control system according to an embodiment.

FIG. 5 is a view illustrating a procedure in which an electronic device controls a power state of a remote control target device or remotely controls substantial operations in the remote control system according to an embodiment.

FIG. 6 is a view illustrating a procedure in which an electronic device obtains control authority for a remote control target device and performs remote control in the remote control system according to an embodiment.

FIG. 7A or FIG. 7B is a view exemplarily illustrating an operation in which an electronic device obtains connection information or authority information.

FIG. 8 is a block diagram illustrating a remote control target device in a network environment according to various embodiments.

FIG. 9 is a block diagram illustrating an electronic device in a network environment according to various embodiments.

### DETAILED DESCRIPTION

Hereinafter, embodiments of the disclosure are described in detail with reference to the drawings so that those skilled in the art to which the disclosure pertains may easily practice the disclosure. However, the disclosure may be implemented in other various forms and is not limited to the embodiments set forth herein. The same or similar reference denotations may be used to refer to the same or similar elements throughout the specification and the drawings. Further, for clarity and brevity, no description is made of well-known functions and configurations in the drawings and relevant descriptions.

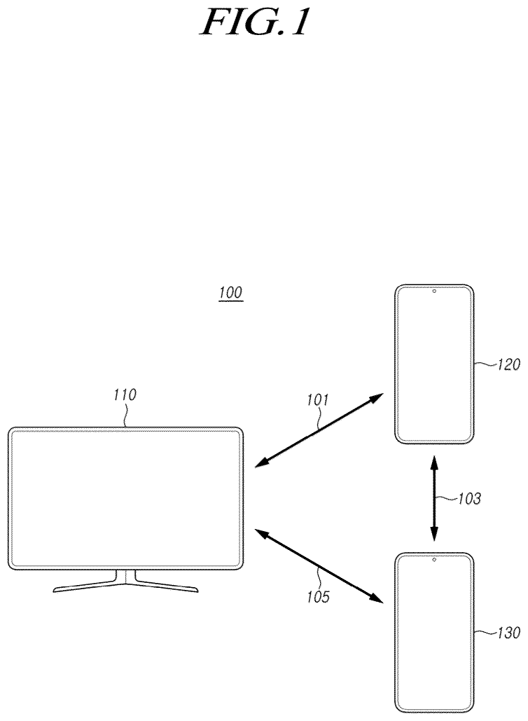

FIG. 1 is a view illustrating a configuration of a remote control system 100 capable of performing remote control based on a network environment according to various embodiments.

Referring to FIG. 1, the remote control system 100 may include a display device 110 corresponding to a remote control target device, or at least one electronic device 120, 130. In the drawings, two electronic devices for performing remote control of the display device 110 are assumed. However, as understood by one or ordinary skill in the art, these configurations are merely exemplary. For example, three or more electronic devices may participate for remote control of the display device 110.

The display device 110 may be remotely controlled by at least one of a first electronic device 120 and/or a second electronic device 130. For remote control including changing a power state of the display device 110, the first and second electronic devices 120, 130 may have control authority for remote control of the display device 110. For example, control authority for remote control may be granted based on whether predetermined information for remotely controlling a power state of the display device 110 and/or remotely controlling operations of the display device 110 is stored. For example, the predetermined information may include connection information with the display device 110. The connection information may be obtained by performing a registration procedure for the display device 110. For example, the connection information may include identification information for identification of the display device 110 (e.g., MAC address), a pairing key, or a wakeup key. For example, the predetermined information may include authority information. The authority information may be obtained by performing a control authority sharing procedure with an electronic device having control authority (e.g., the first electronic device 120). For example, the authority information may include identification information for identification of the display device 110 (e.g., MAC address), a wakeup key, or a temporary key.

For example, the first electronic device 120 may perform a registration procedure 101 with the display device 110 to obtain control authority for remotely controlling the remote control target device 110. The display device 110 may verify whether the first electronic device 120 may have control authority by performing the registration procedure and approve the first electronic device 120 to store the connection information. The first electronic device 120 may remotely control the power state of the display device 110 based on the connection information. The display device 110 may change the power state in response to remote control by the first electronic device 120 having the control authority (e.g., change from a sleep state to an idle state). The first electronic device 120 may remotely control operations of the display device 110 based on the connection information. The display device 110 may perform corresponding operations in response to remote control by the first electronic device 120 having the control authority. In one or more examples, the registration procedure 101 may be initiated by executing a corresponding application on one of devices 120 or 130 that establishes a connection with the display device 110 to obtain the control authority.

In one or more examples, the first electronic device 120 may perform a sharing procedure 103 for sharing control authority for remotely controlling the remote control target device 110 with the second electronic device 130. The sharing procedure 103 may be performed regardless of a state of the display device 110. For example, even in case the display device 110 is powered off, the first electronic device 120 and/or the second electronic device 130 may perform the control authority sharing procedure. For example, the first electronic device 120 may generate authority information required for the second electronic device 130 to access the display device 110 and provide the generated authority information to the second electronic device 130. The second electronic device 130 may perform remote control 105 to change the power state of the display device 110 or execute operations of the display device 110 within a validity time based on the authority information provided from the first electronic device 120.

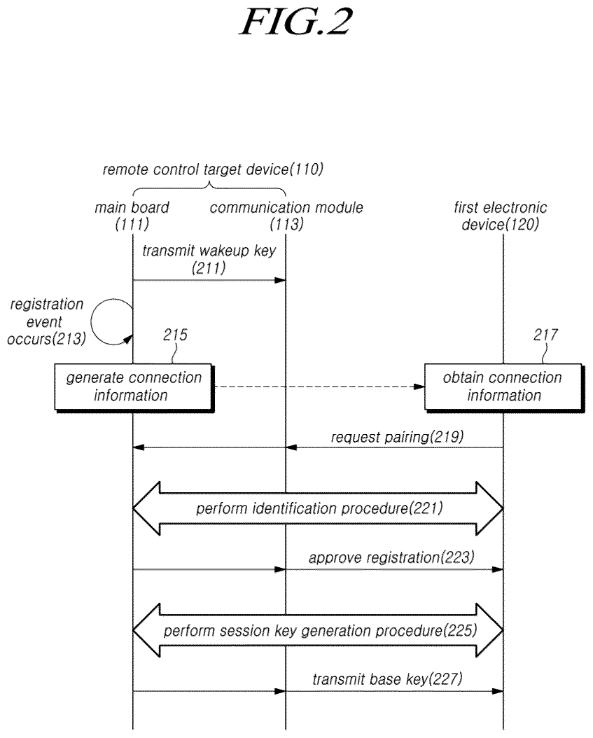

In FIGS. 2 to 6 of the disclosure, the remote control target device 110 (e.g., the display device 110 of FIG. 1) (hereinafter referred to as ‘remote control target device 110’) may be a target device to be remotely controlled by the first electronic device 120. For example, the remote control target device 110 may be an electronic device that substantially includes a display, such as a television or a monitor. For example, the remote control target device 110 may be an electronic device that may output a video signal and/or an audio signal so that an image may be output through another object such as a display device or a screen, although it does not substantially include a display, such as a settop box or a projector. Although one target device 110 is illustrated in FIGS. 2 to 6, the embodiments are not limited to this disclosure. For example, the first electronic device 120 may simultaneously control more than target device.

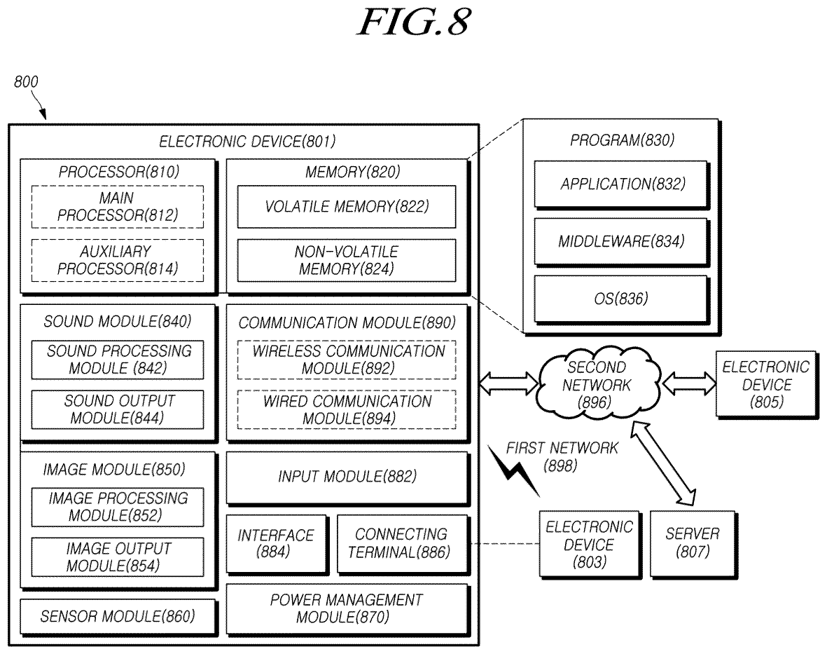

In one or more examples, the remote control target device 110 may include a main board (e.g., the main board 111 of FIGS. 2 to 6) or a communication module (e.g., the communication module 113 of FIGS. 2 to 6). The communication module 113 may include components (e.g., the communication module 890, the interface 884, or the connecting terminal 886 of FIG. 8) for performing communication with another device (e.g., the electronic devices 803, 805 or the server 807 of FIG. 8) based on a predetermined network (e.g., the first network 898 or the second network 896 of FIG. 8) among components (e.g., components of the display device 801 of FIG. 8) included in the remote control target device 110. The communication module 113 may, for example, transmit a video signal to be output by the remote control target device 110 to another device, or receive a video signal transmitted by another device. The communication module 113 may, e.g., transmit an audio signal to be output by the remote control target device 110 to another device, or receive an audio signal transmitted by another device. The communication module 113 may, e.g., transmit a video signal and/or an audio signal to be output by the remote control target device 110 to another device, or receive a video signal and/or an audio signal transmitted by another device. The communication module 113 may, e.g., output a video signal to be output by the remote control target device 110 to a first external device (e.g., a display device such as a monitor), and output an audio signal to be output by the remote control target device 110 to a second external device (e.g., an external speaker such as a Bluetooth speaker). The communication module 113 may, e.g., receive a video signal transmitted by the first external device and receive an audio signal transmitted by the second external device.

For example, the communication module 113 may include a communication circuit (e.g., the wireless communication module 892 of FIG. 8) that provides direct wireless connection such as Bluetooth, Wi-Fi Direct, or Wi-Fi Aware with an electronic device (e.g., the first electronic device 120 or the second electronic device 130 of FIG. 1) such as a remote control or a smartphone for remotely controlling itself. For example, the communication module 113 may include an interface (e.g., the interface 884 or the wired communication module 894 of FIG. 8) that may transmit or receive a video signal and/or an audio signal to another device such as a monitor or a speaker through a connecting terminal (e.g., the connecting terminal 886 of FIG. 8) such as a display port (DP), a high definition multimedia interface (HDMI) port, an RGB port, or a Thunderbolt port. The interface included in the communication module 113 may include one interface that provides input/output together, or may separately include an input interface that provides input and an output interface that provides output.

For example, the main board 111 may include some or all of the remaining components except for the communication module 113 among the components included in the remote control target device 110. The main board 111 may, e.g., include some or all of the remaining components (e.g., the processor 810, the memory 820, the audio module 840, the video module 850, the sensor module 860, or the power management module 870 of FIG. 8) except for the communication module 113 among the components included in the remote control target device 110. For example, the main board 111 may include the processor 810, the memory 820, or the power management module 870 among the components included in the remote control target device 110.

In the disclosure, it is assumed that a state of the remote control target device 110 includes a sleep state, an idle state, or an active state, but this is merely exemplary. For example, the remote control target device 110 may further include another state, or some states may be omitted. The sleep state may be a state in which the remote control target device 110 operates to generate minimum power consumption. For example, in the sleep state, the remote control target device 110 may be in a state in which the communication module 113 wakes up periodically and/or aperiodically to receive a signal (e.g., a remote control signal) from an external device or transmit a signal (e.g., a beacon message) to an external device. The idle state may be a state in which only components (e.g., the processor 810) having relatively small power consumption in the main board 111 operate except for components having large power consumption such as a display. The active state is a state in which all components (e.g., the main board 111 and the communication module 113) of the remote control target device 110 perform normal operations.

FIG. 2 is a view illustrating a procedure for registering an electronic device (e.g., the first electronic device 120 of FIG. 1) for remote control of a remote control target device (e.g., the display device 110 of FIG. 1) in the remote control system (e.g., the remote control system 100 of FIG. 1) according to an embodiment.

In the following embodiment, each operation may be performed sequentially, but is not necessarily performed sequentially. For example, the order of the operations may be changed, and at least two operations may be performed in parallel. For example, before one operation is completed, another operation may be started.

Referring to FIG. 2, the remote control target device 110 may have basic information set or stored for registering a first electronic device 120 such as a smartphone for remote control. The remote control target device 110 may, e.g., have basic information set or stored during a production process and/or during factory reset. For example, the basic information may include a base key or a wakeup key. The remote control target device 110 may have identification information (e.g., a media access control address (MAC address)) that may identify itself set during initial installation.

In operation 211, the remote control target device 110 may operate so that the wakeup key is transferred from the main board 111 to the communication module 113 in response to occurrence of a predetermined event. For example, the predetermined event may be a completion event of factory reset. For example, the predetermined event may be an event in which power is supplied to the remote control target device 110 for the first time. In one or more examples, the predetermined event may be a predetermined time of day (e.g., noon).

In operation 213, the remote control target device 110 may monitor whether a registration event of the first electronic device 120 for remote control occurs. For example, the remote control target device 110 may recognize the supply of power as occurrence of a registration event. For example, the remote control target device 110 may recognize a pressing of a physical button provided on the panel as occurrence of a registration event. For example, the remote control target device 110 may recognize the reception of a registration request signal for remote control from a remote control as occurrence of a registration event.

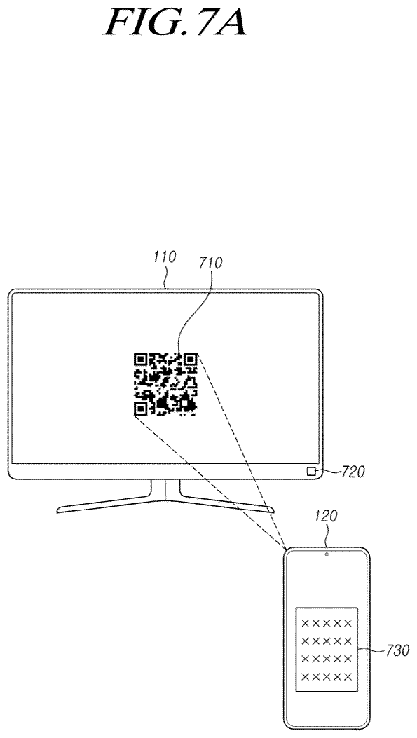

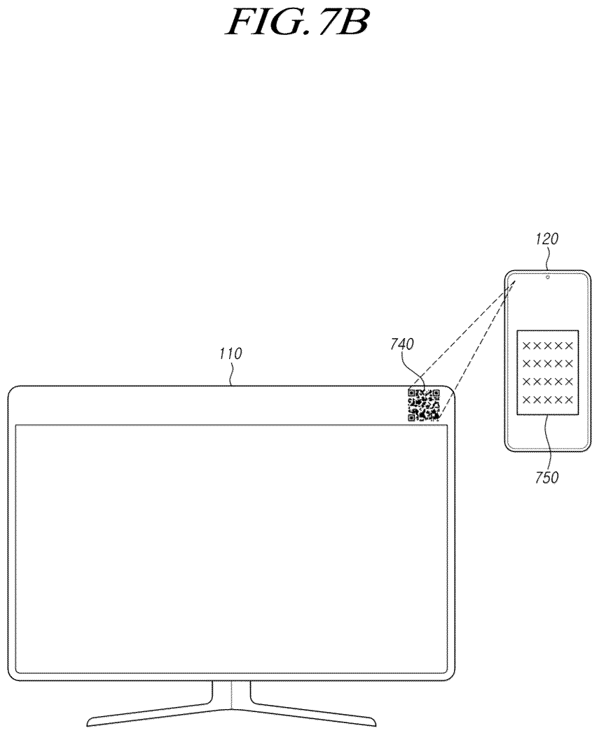

Based on the remote control target device 110 recognizing occurrence of a registration event, in operation 215, it may generate connection information. The connection information may, e.g., include identification information (e.g., MAC address), a temporary key, or a wakeup key. The temporary key may have a validity time. For example, the temporary key may be valid for a preset time period (e.g., 5 minutes) from the generated time. The validity time of the temporary key may be renewed as needed. The temporary key may be derived from the base key included in the basic information. For example, the remote control target device 110 may generate connection information including identification information (e.g., MAC address), a temporary key, or a wakeup key as a predetermined identifier. The predetermined identifier may be a quick response code (QR code) including identification information (e.g., MAC address), a temporary key, or a wakeup key. For example, the remote control target device 110 may display a QR code on a display (see FIG. 7A). For example, the remote control target device 110 may transmit corresponding information to an external display device so that the QR code may be displayed on the external display device (e.g., a monitor or a screen).

In operation 217, the first electronic device 120 may obtain the connection information provided by the remote control target device 110. For example, the first electronic device 120 may obtain the connection information by capturing the displayed QR code. The QR code may be displayed on a display of the remote control target device 110, or displayed on an external display device (e.g., a monitor or a screen) electrically connected to the remote control target device 110. For example, the first electronic device 120 may obtain the connection information by capturing a QR code attached to a front panel of the remote control target device 110. The first electronic device 120 may obtain identification information (e.g., MAC address) configured to identifying the remote control target device 110, a temporary key having a validity time, or a wakeup key from the connection information. The first electronic device 120 may store the obtained identification information (e.g., MAC address), the temporary key having the validity time, or the wakeup key in memory. For example, the first electronic device 120 may obtain the connection information from a QR sticker or a near field communication (NFC) sticker. For example, a QR sticker or an NFC sticker on which the connection information is recorded may be attached to an externally identifiable portion such as a front panel of the remote control target device 110 during a manufacturing process (see FIG. 7B). In this case, the first electronic device 120 may obtain identification information (e.g., MAC address), a temporary key, or a wakeup key corresponding to the connection information by capturing or tagging the QR sticker or the NFC sticker.

In operation 219, the first electronic device 120 may request pairing to the remote control target device 110 using the identification information (e.g., MAC address). The pairing request may be a request for approval of connection to the remote control target device 110 and/or control authority for remote control. The first electronic device 120 may transfer identification information for identifying itself to the remote control target device 110 based on requesting pairing.

Based on the remote control target device 110 receiving a pairing request from the first electronic device 120, in operation 221, it may perform a registration procedure with the first electronic device 120. For example, the remote control target device 110 may transmit a temporary value (also referred to as a nonce) to the first electronic device 120. The nonce may be a random value. The first electronic device 120 may encrypt the nonce received from the remote control target device 110 with the temporary key obtained from the connection information to generate an encrypted value. For example, the first electronic device 120 may generate a hash value obtained by hashing the nonce with the temporary key as an encrypted value. The first electronic device 120 may transmit the encrypted value to the remote control target device 110. The remote control target device 110 may decrypt the encrypted value received from the first electronic device 120 using the temporary key. The remote control target device 110 may identify whether a nonce obtained by decrypting the encrypted value matches the nonce previously transmitted to the first electronic device 120. For example, that the nonce obtained by decrypting the encrypted value matches the nonce transmitted to the first electronic device 120 may mean that verification of the temporary key has succeeded. Based on the two nonces matching, the remote control target device 110 may grant control authority for connection to the first electronic device 120 and/or remote control. The remote control target device 110 may register information about the first electronic device 120 to which control authority has been granted in a remote control approval list.

Based on connection to the first electronic device 120 being successful and/or control authority being granted, in operation 223, the remote control target device 110 may transmit a registration approval message to the first electronic device 120.

Based on the first electronic device 120 receiving the registration approval message from the remote control target device 110, the first electronic device 120 may register information about the remote control target device 110 in a remote control target management list. The first electronic device 120 may recognize that it has control authority to remotely control the remote control target device 110 by receiving the registration approval message. The registration approval may occur without or without user input. In one or more examples, the registration approval may be automatically performed by the first electronic device 120 without requiring approval from the user. A message may be displayed to the user of the first electronic device 120 indicating approval of registration. In one or more examples, a message may be displayed to a user requesting the user's approval (e.g., via selection of a button on the display of the first electronic device 120) of the registration.

Based on the first electronic device 120 having control authority for the remote control target device 110, in operation 225, it may perform a procedure for generating a session key for verifying control authority based on connecting with the remote control target device 110 for subsequent remote control. For example, the remote control target device 110 and the first electronic device 120 may generate a session key based on a specific algorithm. For example, the specific algorithm for generating the session key may be a Diffie-Hellman algorithm. As understood by one of ordinary skill in the art, the Diffie-Hellman algorithm is an algorithm that enables exchange of a secret key in a predetermined network environment without prior secret exchange. The remote control target device 110 and the first electronic device 120 may obtain the same session key by performing the procedure for generating the session key. The session key may be used for the remote control target device 110 to verify control authority based on receiving a connection request from the first electronic device 120, but may also be used to encrypt signals or data transmitted and received in a communication channel between the remote control target device 110 and the first electronic device 120.

In operation 227, the remote control target device 110 may encrypt the base key with the session key and transmit the encrypted base key to the first electronic device 120. Since the first electronic device 120 knows the session key, the first electronic device 120 may decrypt the encrypted base key received from the remote control target device 110 using the session key and store the decrypted base key.

By performing the above-described registration procedure, the first electronic device 120 granted with control authority to perform remote control of the remote control target device 110 may obtain and store identification information (e.g., MAC address) for identifying the remote control target device 110, the base key, the wakeup key, and the session key. For example, the first electronic device 120 may control the power state of the remote control target device 110 using the identification information (e.g., MAC address), the base key, the wakeup key, and the session key. For example, the first electronic device 120 may perform remote control for substantial operations of the remote control target device 110 using the identification information (e.g., MAC address), the base key, the wakeup key, and the session key. For example, the first electronic device 120 may perform a control authority sharing procedure for another electronic device (e.g., the second electronic device 130 of FIG. 1) using the identification information (e.g., MAC address), the base key, the wakeup key, and the session key.

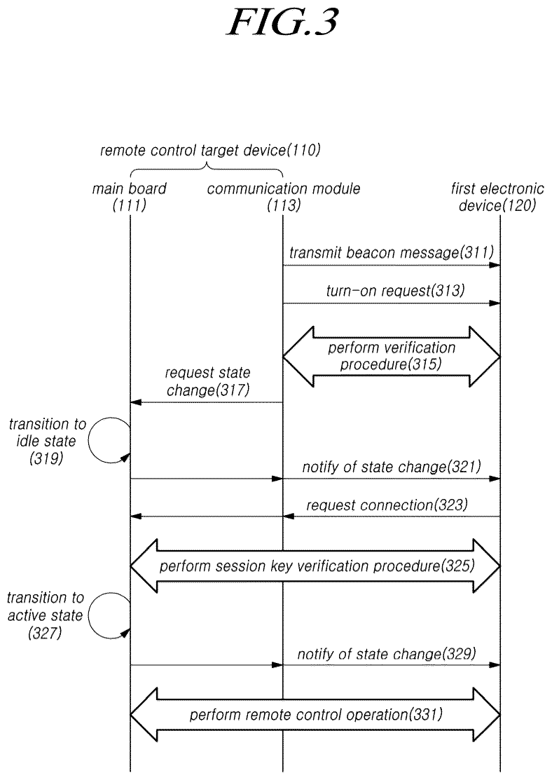

FIG. 3 is a view illustrating a procedure in which an electronic device (e.g., the first electronic device 120 of FIG. 1) controls a power state of a remote control target device (e.g., the display device 110 of FIG. 1) or remotely controls substantial operations in the remote control system (e.g., the remote control system 100 of FIG. 1) according to an embodiment.

The first electronic device 120 referenced in FIG. 3 is assumed to be in a state of being granted control authority for remote control from the remote control target device 110 by performing the procedure described with reference to FIG. 2. Among the procedures illustrated in FIG. 3, an operation of controlling the power state of the remote control target device 110 performed by operations 311 to 321 may be performed under the assumption that a state of the remote control target device 110 is the sleep state. For example, based on a state of the remote control target device 110 being the idle state, only an operation for remotely controlling the remote control target device 110 performed by operations 323 to 331 among the procedures illustrated in FIG. 3 may be performed. For example, based on a state of the remote control target device 110 being the active state, among operations 323 to 331 illustrated in FIG. 3, an operation of transitioning from the idle state to the active state and operations 327 and 329 of transferring a state change notification for guiding transition to the active state may be omitted. In the following, it is described that all illustrated operations are performed assuming that a state of the remote control target device 110 is the sleep state, but some operations to be described by state of the remote control target device 110 may be omitted as mentioned above. For reference, distinction indices (e.g., first, second, or third) used to distinguish temporary values or encrypted values in the description of FIG. 3 are only referenced to describe operations illustrated in FIG. 3, and may not match distinction indices described in other drawings or claims.

In the following embodiment, each operation may be performed sequentially, but is not necessarily performed sequentially. For example, the order of the operations may be changed, and at least two operations may be performed in parallel.

Referring to FIG. 3, in operation 311, the remote control target device 110 may transmit a beacon message. For example, the communication module 113 of the remote control target device 110 in the sleep state may wake up periodically and transmit a beacon message including a second temporary value. The beacon message transmitted by the remote control target device 110 may be received by all unspecified multiple electronic devices in the vicinity.

In operation 311, the first electronic device 120 may receive the beacon message transmitted by the remote control target device 110. The first electronic device 120 may obtain the second temporary value included in the received beacon message.

In operation 313, the first electronic device 120 may transmit a turn-on request requesting the remote control target device 110 in the sleep state to wake up. For example, the first electronic device 120 may encrypt the second temporary value using the wakeup key to generate a second encrypted value. For example, the first electronic device 120 may generate a hash value obtained by hashing the second temporary value with the wakeup key as the second encrypted value. The first electronic device 120 may transmit the generated second encrypted value to the remote control target device 110 in the sleep state.

Based on the remote control target device 110 receiving the turn-on request from the first electronic device 120, in operation 315, it may perform a verification procedure for whether the first electronic device 120 has control authority to remotely control its power state.

For example, the remote control target device 110 may decrypt the second encrypted value received from the first electronic device 120 using the wakeup key. The remote control target device 110 may identify whether a temporary value obtained by decrypting the second encrypted value matches the second temporary value included in the beacon message and transmitted by itself. For example, that the temporary value obtained by decrypting the second encrypted value matches the second temporary value may mean that control authority to remotely control its power state has been granted to the first electronic device 120. The above-described verification procedure may be performed by the communication module 113 of the remote control target device 110. Based on the temporary value obtained by decrypting the second encrypted value matching the second temporary value, in operation 317, the communication module 113 may request the main board 111 to change the state.

For example, based on the remote control target device 110 receiving the second encrypted value from the first electronic device 120, it may encrypt the second temporary value included in the beacon message and transmitted by itself with the wakeup key stored by itself to generate an encrypted value for verification. The remote control target device 110 may identify whether the encrypted value generated for verification matches the second encrypted value received from the first electronic device 120. For example, that the encrypted value generated for verification matches the second encrypted value may mean that control authority to remotely control its power state has been granted to the first electronic device 120. The above-described verification procedure may be performed by the communication module 113 of the remote control target device 110. Based on the second encrypted value matching the encrypted value generated by itself for verification, in operation 317, the communication module 113 may request the main board 111 to change the state.

Based on the remote control target device 110 determining that the first electronic device 120 has control authority to control the power state by remote control, in operation 319, it may transition a state from the sleep state to the idle state. The idle state may be a state that allows only power consumption by some components (e.g., the processor 810) except for components having relatively large power consumption (e.g., a display) as defined above.

In operation 321, the remote control target device 110 may transmit a first state change notification message indicating that the state has changed to the idle state to the first electronic device 120. The first state change notification message may include first identification information indicating that a state of the remote control target device 110 has changed from the sleep state to the idle state.

In operation 321, the first electronic device 120 may receive the first state change notification message from the remote control target device 110. The first electronic device 120 may recognize that a state of the remote control target device 110 has changed from the sleep state to the idle state by the first identification information included in the received first state change notification message.

In operation 323, the first electronic device 120 may request connection to the remote control target device 110. For example, based on a remote control request for the remote control target device 110 occurring, the first electronic device 120 may transmit a connection request to the remote control target device 110 in response thereto.

Based on the connection request being transmitted to the remote control target device 110 by the first electronic device 120, the remote control target device 110 and the first electronic device 120 may perform a session verification procedure. For example, the remote control target device 110 may transmit a third nonce to the first electronic device 120. The third nonce may be a random value. The first electronic device 120 may encrypt the third nonce received from the remote control target device 110 with the stored session key to generate a third encrypted value. For example, the first electronic device 120 may generate a hash value obtained by hashing the third nonce with the session key as the third encrypted value. The first electronic device 120 may transmit the third encrypted value to the remote control target device 110. The remote control target device 110 may decrypt the third encrypted value received from the first electronic device 120 using the session key stored by itself. The remote control target device 110 may identify whether a temporary value obtained by decrypting the third encrypted value matches the third nonce previously transmitted to the first electronic device 120. For example, that the temporary value obtained by decrypting the third encrypted value matches the third nonce may mean that verification of the session key has succeeded. Based on the two temporary values matching, the remote control target device 110 may approve connection to the first electronic device 120 and/or remote control.

Based on session key verification for the first electronic device 120 being successful, in operation 327, the remote control target device 110 may transition a state from the idle state to the active state. The active state may be a state in which substantially all components are awake so that all functions of the remote control target device 110 may be performed normally as defined above.

In operation 329, the remote control target device 110 may transmit a second state change notification message indicating that the state has changed to the active state to the first electronic device 120. The second state change notification message may include second identification information indicating that a state of the remote control target device 110 has changed from the idle state to the active state.

In operation 329, the first electronic device 120 may receive the second state change notification message from the remote control target device 110. The first electronic device 120 may recognize that a state of the remote control target device 110 has changed from the idle state to the active state by the second identification information included in the received second state change notification message.

Based on a state of the remote control target device 110 transitioning to the active state, in operation 331, the remote control target device 110 and the first electronic device 120 may perform a remote control operation. For example, the first electronic device 120 may execute an application for remote control and transmit a remote control signal corresponding to the user's manipulation through the user interface according to execution of the application to the remote control target device 110. The remote control target device 110 may perform an operation corresponding to the remote control signal received from the first electronic device 120. The types of remote control operations include, but are not limited to, powering down the remote control target device 110, changing a channel, closing or opening an application, controlling playback of content, etc.

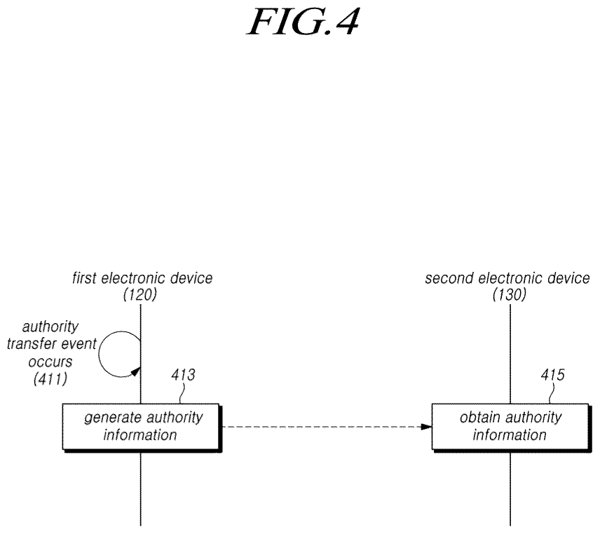

FIG. 4 is a view illustrating a procedure in which a first electronic device (e.g., the first electronic device 120 of FIG. 1) shares control authority for remotely controlling a remote control target device (e.g., the display device 110 of FIG. 1) with a second electronic device (e.g., the second electronic device 130 of FIG. 1) in the remote control system (e.g., the remote control system 100 of FIG. 1) according to an embodiment.

In the description with reference to FIG. 4 to be described below, it is assumed that the first electronic device 120 is an electronic device that has obtained control authority to remotely control the remote control target device 110, and the second electronic device 130 is an electronic device that has not obtained control authority to remotely control the remote control target device 110. A procedure in which the first electronic device 120 obtains control authority to remotely control the remote control target device 110 may be the same as described above.

In the following embodiment, each operation may be performed sequentially, but is not necessarily performed sequentially. For example, the order of the operations may be changed, and at least two operations may be performed in parallel.

Referring to FIG. 4, in operation 411, the first electronic device 120 may monitor whether an authority transfer event occurs. The authority transfer event may, e.g., be caused by a control authority sharing request. For example, the first electronic device 120 may recognize a control authority sharing request for remote control by the user's input through an execution screen of a specific application based on the specific application for remote control being executed. For example, the first electronic device 120 may receive a control authority sharing request for remote control from the second electronic device 130. To this end, the first electronic device 120 and the second electronic device 130 should not only recognize each other's existence, but also have a communication link formed that may provide information exchange between them. For example, the first electronic device 120 may receive a control authority sharing request for remote control from the remote control target device 110 to the second electronic device 130.

Based on an authority transfer event occurring, in operation 413, the first electronic device 120 may generate information about control authority for sharing control authority (hereinafter referred to as ‘authority information’). For example, the first electronic device 120 may generate authority information using one or more of identification information (e.g., MAC address) of the remote control target device 110, a wakeup key, or a temporary key. The first electronic device 120 may already store identification information (e.g., MAC address) and a wakeup key of the remote control target device 110 by the registration procedure described with reference to FIG. 2. The first electronic device 120 may obtain a temporary key by deriving it from the base key. For example, the first electronic device 120 may derive a temporary key by encrypting information about current time with the base key. For example, the first electronic device 120 may obtain a hash value obtained by hashing information about current time with the base key as the temporary key. The first electronic device 120 may also already store the base key by the registration procedure described with reference to FIG. 2. The temporary key may have a validity time. For example, the temporary key may be valid for a preset time period (e.g., 1 hour or 30 minutes) from the generated time. The validity time of the temporary key may be renewed as needed. Information about current time may, e.g., be information (e.g., 10 o'clock) excluding minutes and/or seconds from time (e.g., 10:25:30) that may be represented in hours, minutes, and seconds. In this case, the validity time may be determined in hour units (e.g., 1 hour). Information about current time may, e.g., be information (e.g., 10:20) excluding minutes in two-digit units or less (e.g., 1 to 9 minutes) and seconds from time (e.g., 10:25:30) that may be represented in hours, minutes, and seconds. In this case, the validity time may be determined in 10-minute units (e.g., 30 minutes).

For example, the first electronic device 120 may generate a QR code including identification information (e.g., MAC address), a wakeup key, or a temporary key as a predetermined identifier for authority information. The first electronic device 120 may display the QR code on a display. The first electronic device 120 may transfer corresponding information to another electronic device so that the QR code may be displayed on the another electronic device (e.g., TV, monitor, or screen).

For example, the first electronic device 120 and the second electronic device 130 may recognize each other's existence and further have a communication link (or communication channel) formed to enable information exchange between them. In this case, the first electronic device 120 may transfer authority information including identification information (e.g., MAC address), a wakeup key, or a temporary key to the second electronic device 130 based on a specific means such as a messenger application. For example, the first electronic device 120 may transfer authority information to the second electronic device 130 in the form such as a URL.

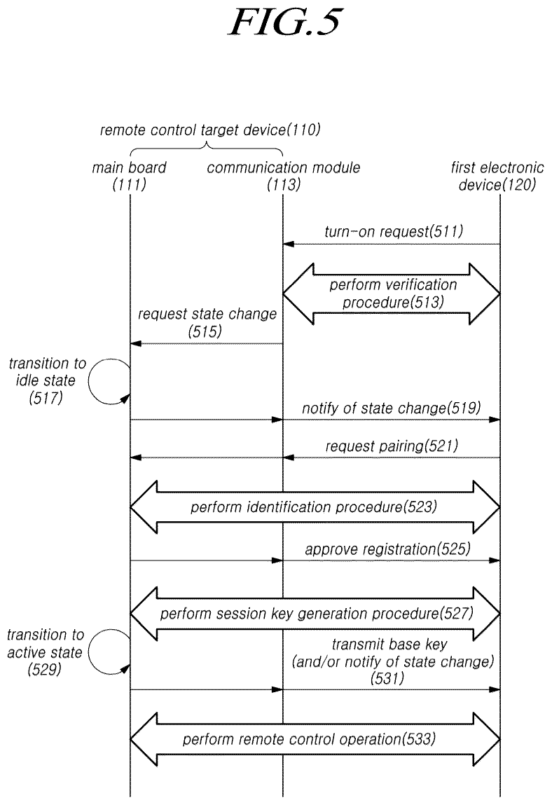

In operation 415, the second electronic device 130 may obtain the authority information provided by the first electronic device 120. For example, the second electronic device 130 may obtain the authority information by capturing the QR code displayed on the display of the first electronic device 120. For example, the second electronic device 130 may obtain the authority information by information (e.g., URL information) received from the first electronic device 120. The second electronic device 130 may obtain identification information (e.g., MAC address) capable of identifying the remote control target device 110, a temporary key having a validity time, or a wakeup key from the authority information. The second electronic device 130 may store the obtained identification information (e.g., MAC address), a second temporary key having a validity time, or a wakeup key in memory. Since the temporary key has a validity time, the second electronic device 130 needs to access the remote control target device 110 within the validity time and perform a subsequent operation (e.g., an operation according to FIG. 5) to maintain control authority even after the validity time elapses and the temporary key is discarded. In one or more examples, the remote control target device 110 may control whether the second electronic device 130 is permitted to access the authority information. For example, the remote control target device 110 may have a block list that is transferred to the first electronic device 120, where if the second electronic device 130 is included on this list, the first electronic device 120 is not permitted to transfer the authority information to the second electronic device 130.

FIG. 5 is a view illustrating a procedure in which an electronic device (e.g., the second electronic device 130 of FIG. 1) controls a power state of a remote control target device (e.g., the display device 110 of FIG. 1) or remotely controls substantial operations in the remote control system (e.g., the remote control system 100 of FIG. 1) according to an embodiment.

In the following embodiment, each operation may be performed sequentially, but is not necessarily performed sequentially. For example, the order of the operations may be changed, and at least two operations may be performed in parallel.

The second electronic device 130 referenced in FIG. 5 is assumed to be in a state of receiving control authority for remote control shared from the first electronic device 120 by performing the procedure described with reference to FIG. 4. Among the procedures illustrated in FIG. 5, an operation of controlling the power state of the remote control target device 110 performed by operations 511 to 519 may be performed under the assumption that a state of the remote control target device 110 is the sleep state. For example, based on a state of the remote control target device 110 being the idle state, only an operation for remotely controlling the remote control target device 110 performed by operations 521 to 533 among the procedures illustrated in FIG. 5 may be performed. For example, based on a state of the remote control target device 110 being the active state, among operations 521 to 533 illustrated in FIG. 5, an operation of transitioning from the idle state to the active state and an operation of transferring a state change notification for guiding transition to the active state may be omitted. In the following, it is described that all illustrated operations are performed assuming that a state of the remote control target device 110 is the sleep state, but some operations to be described by state of the remote control target device 110 may be omitted as mentioned above. For reference, distinction indices (e.g., first, second, or third) used to distinguish temporary values, encrypted values, state change notification messages, identification information, or temporary keys in the description of FIG. 5 are only referenced to describe operations illustrated in FIG. 5, and may not match distinction indices described in other drawings or claims.

Referring to FIG. 5, in operation 511, the second electronic device 130 may transmit a turn-on request requesting the remote control target device 110 in the sleep state to wake up using identification information (e.g., MAC address) and a wakeup key stored due to control authority sharing. For example, the second electronic device 130 may receive a first temporary value from the remote control target device 110. The second electronic device 130 may encrypt the first temporary value using the wakeup key to generate a first encrypted value. For example, the second electronic device 130 may generate a hash value obtained by hashing the first temporary value with the wakeup key as the first encrypted value. The second electronic device 130 may transmit the generated first encrypted value to the remote control target device 110 in the sleep state.

Based on the remote control target device 110 receiving the turn-on request from the second electronic device 130, in operation 513, it may perform a verification procedure for whether the second electronic device 130 has control authority to remotely control its power state.

For example, the remote control target device 110 may decrypt the first encrypted value received from the second electronic device 130 using the wakeup key. The remote control target device 110 may identify whether a temporary value obtained by decrypting the first encrypted value matches the first temporary value transmitted by itself. For example, that the temporary value obtained by decrypting the first encrypted value matches the first temporary value may mean that the second electronic device 130 has control authority to remotely control the power state of the remote control target device 110. The above-described verification procedure may be performed by the communication module 113 of the remote control target device 110. Based on the temporary value obtained by decrypting the first encrypted value matching the first temporary value, in operation 515, the communication module 113 may request the main board 111 to change the state.

For example, based on the remote control target device 110 receiving the first encrypted value from the second electronic device 130, it may encrypt the first temporary value transmitted by itself with the wakeup key stored by itself to generate an encrypted value for verification. The remote control target device 110 may identify whether the encrypted value generated for verification matches the first encrypted value received from the second electronic device 130. For example, that the encrypted value generated for verification matches the first encrypted value may mean that the second electronic device 130 has control authority to remotely control the power state of the remote control target device 110. The above-described verification procedure may be performed by the communication module 113 of the remote control target device 110. Based on the encrypted value generated for verification matching the first encrypted value, in operation 515, the communication module 113 may request the main board 111 to change the state.

Based on the remote control target device 110 determining that the second electronic device 130 has control authority to control the power state by remote control, in operation 517, it may transition from the sleep state to the idle state. The idle state may be a state that allows only power consumption by some components (e.g., the processor 810) except for components having relatively large power consumption (e.g., a display) as defined above.

In operation 519, the remote control target device 110 may transmit a first state change notification message indicating that it has changed to the idle state to the second electronic device 130. The first state change notification message may include first identification information indicating that a state of the remote control target device 110 has changed from the sleep state to the idle state.

In operation 519, the second electronic device 130 may receive the first state change notification message from the remote control target device 110. The second electronic device 130 may recognize that a state of the remote control target device 110 has changed from the sleep state to the idle state by the first identification information included in the received first state change notification message.

In operation 521, the second electronic device 130 may make a pairing request to the remote control target device 110. For example, based on a remote control request for the remote control target device 110 occurring, the second electronic device 130 may transmit a connection request to the remote control target device 110 in response thereto.

Based on the connection request being transmitted to the remote control target device 110 by the second electronic device 130, in operation 523, the remote control target device 110 may perform an identification procedure for whether the second electronic device 130 has control authority for remote control.

For example, the second electronic device 130 may transmit a first temporary key stored due to control authority sharing to the remote control target device 110. For example, the first temporary key may be derived from the base key by the first electronic device 120. For example, the first temporary key may be derived by the first electronic device 120 encrypting information about current time with the base key. For example, the first temporary key may be obtained by the first electronic device 120 hashing information about current time with the base key. The first temporary key may have a validity time. For example, the first temporary key may be valid for a preset time period (e.g., 1 hour or 30 minutes) from a time generated by the first electronic device 120. Information about current time may, e.g., be information (e.g., 10 o'clock) excluding minutes and/or seconds from time (e.g., 10:25:30) that may be represented in hours, minutes, and seconds. In this case, the validity time may be determined in hour units (e.g., 1 hour). Information about current time may, e.g., be information (e.g., 10:20) excluding minutes in two-digit units or less (e.g., 1 to 9 minutes) and seconds from time (e.g., 10:25:30) that may be represented in hours, minutes, and seconds. In this case, the validity time may be determined in 10-minute units (e.g., 30 minutes).

Based on the remote control target device 110 receiving the first temporary key from the second electronic device 130, it may derive a second temporary key using the base key stored by itself. For example, the remote control target device 110 may derive the second temporary key by encrypting information about current time with the base key. For example, the second temporary key may be obtained by the remote control target device 110 hashing information about current time corresponding to a time when the first temporary key is received from the second electronic device 130 with the base key. The second temporary key may also have a validity time. For example, the validity time of the second temporary key may be relatively shorter than the validity time of the first temporary key. For example, the second temporary key may be valid for a preset time period (e.g., 10 minutes) from an arbitrary time after receiving the first temporary key from the second electronic device 130. Information about current time may, e.g., be information (e.g., 10 o'clock) excluding minutes and/or seconds from time (e.g., 10:25:30) that may be represented in hours, minutes, and seconds. Information about current time may, e.g., be information (e.g., 10:20) excluding minutes in two-digit units or less (e.g., 1 to 9 minutes) and seconds from time (e.g., 10:25:30) that may be represented in hours, minutes, and seconds.

The remote control target device 110 may compare the first temporary key and the second temporary key and determine whether the second electronic device 130 has control authority for remote control based on whether the two temporary keys are identical. For example, based on the first temporary key and the second temporary key being identical, the remote control target device 110 may determine that the second electronic device 130 has control authority for remote control. For example, based on the first temporary key and the second temporary key not being identical, the remote control target device 110 may determine that the second electronic device 130 does not have control authority for remote control.

Based on the remote control target device 110 determining that the second electronic device 130 has control authority for remote control, in operation 525, it may transmit a message approving registration to the second electronic device 130.

Based on verification that the second electronic device 130 has control authority being completed, in operation 527, the remote control target device 110 and the second electronic device 130 may perform a procedure for generating a session key. For example, the remote control target device 110 and the second electronic device 130 may generate a session key based on a specific algorithm. For example, the specific algorithm for generating the session key may be the Diffie-Hellman algorithm. The Diffie-Hellman algorithm is an algorithm that enables exchange of a secret key in a predetermined network environment without prior secret exchange. The remote control target device 110 and the second electronic device 130 may obtain the same session key by performing the procedure for generating the session key. The session key may be used for the remote control target device 110 to verify control authority based on receiving a connection request from the second electronic device 130, but may also be used to encrypt signals or data transmitted and received in a communication channel between the remote control target device 110 and the second electronic device 130.

Based on the session key generation procedure with the second electronic device 130 being completed, in operation 529, the remote control target device 110 may transition from the idle state to the active state. The active state may be a state in which substantially all components are awake so that all functions of the remote control target device 110 may be performed normally as defined above.

In operation 531, the remote control target device 110 may encrypt the base key with the session key and transmit the encrypted base key to the second electronic device 130. In operation 531, the remote control target device 110 may transmit a second state change notification message indicating that it has changed to the active state to the second electronic device 130. The second state change notification message may include second identification information indicating that a state of the remote control target device 110 has changed from the idle state to the active state.

In operation 531, the second electronic device 130 may receive the encrypted base key and/or the second state change notification message. Since the second electronic device 130 knows the session key, it may decrypt the encrypted base key received from the remote control target device 110 using the session key and store the decrypted base key. The second electronic device 130 may recognize that the remote control target device 110 has changed from the idle state to the active state by the second identification information included in the received second state change notification message.

Based on the state of the remote control target device 110 transitioning to the active state, in operation 533, the remote control target device 110 and the second electronic device 130 may perform a remote control operation. For example, the second electronic device 130 may execute an application for remote control and transmit a remote control signal corresponding to the user's manipulation through the user interface according to execution of the application to the remote control target device 110. The remote control target device 110 may perform an operation corresponding to the remote control signal received from the second electronic device 130. Operation 533 may correspond to operation 331 (FIG. 3).

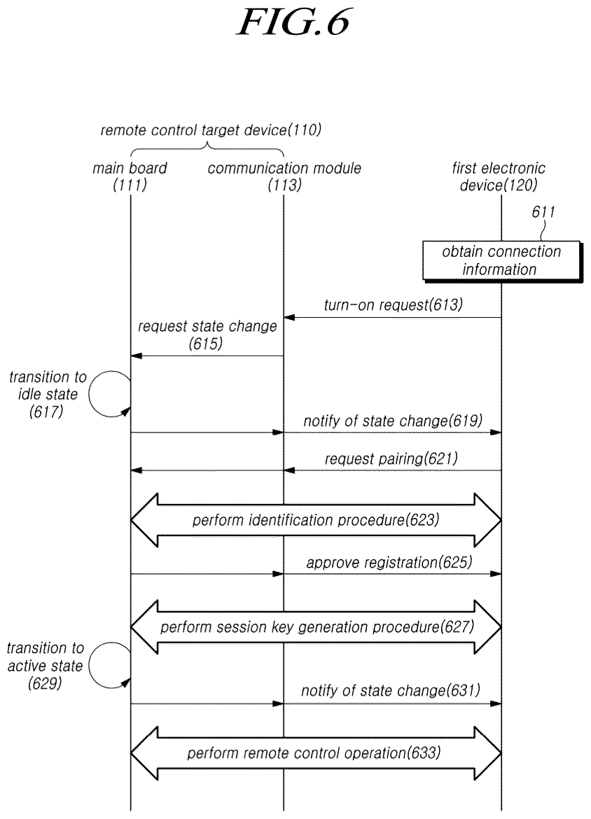

FIG. 6 is a view illustrating a procedure in which an electronic device (e.g., the second electronic device 130 of FIG. 1) obtains control authority for a remote control target device (e.g., the display device 110 of FIG. 1) (hereinafter referred to as ‘remote control target device 110’) and performs remote control in the remote control system (e.g., the remote control system 100 of FIG. 1) according to an embodiment.

In the following embodiment, each operation may be performed sequentially, but is not necessarily performed sequentially. For example, the order of the operations may be changed, and at least two operations may be performed in parallel.

Referring to FIG. 6, in operation 611, the second electronic device 130 may obtain connection information. For example, the second electronic device 130 may obtain the connection information by capturing a QR code or tagging an NFC sticker. The QR code may, e.g., be attached to an externally identifiable portion such as a front panel of the remote control target device 110 during a manufacturing process (see FIG. 7B). The QR code may, e.g., be attached to an externally identifiable portion such as a front panel of the remote control target device 110 at an arbitrary time after a product is shipped (e.g., a time of being displayed or stored for sale, a time of being installed after sale, or an arbitrary time while using a product) (see FIG. 7B). An NFC sticker may, e.g., be attached to an externally identifiable portion such as a front panel of the remote control target device 110 during a manufacturing process. An NFC sticker may, e.g., be attached to an externally identifiable portion such as a front panel of the remote control target device 110 at an arbitrary time after a product is shipped (e.g., a time of being displayed or stored for sale, a time of being installed after sale, or an arbitrary time while using a product).

The second electronic device 130 may obtain identification information (e.g., MAC address) capable of identifying the remote control target device 110, a wakeup key, or a base key from the obtained connection information. The second electronic device 130 may store the obtained identification information (e.g., MAC address), the wakeup key, or the base key in memory.

In operation 613, the second electronic device 130 may transmit a turn-on request using the stored identification information (e.g., MAC address) and the wakeup key. For example, the second electronic device 130 may transmit the turn-on request to control the remote control target device 110 so that the remote control target device 110 in the sleep state wakes up. For example, the second electronic device 130 may receive a first temporary value from the remote control target device 110. The second electronic device 130 may encrypt the first temporary value using the wakeup key to generate a first encrypted value. The second electronic device 130 may transmit the generated first encrypted value to the remote control target device 110 in the sleep state.

Based on the remote control target device 110 receiving the turn-on request from the second electronic device 130, it may perform a verification procedure for whether the second electronic device 130 has control authority to remotely control its power state using the wakeup key. The verification procedure for whether the second electronic device 130 has control authority may be the same as described with reference to FIG. 3 or FIG. 5, so detailed description thereof is omitted.

Based on the remote control target device 110 determining that the second electronic device 130 has control authority to control the power state by remote control, in operation 617, it may transition from the sleep state to the idle state. The idle state may be a state that allows only power consumption by some components (e.g., the processor 810) except for components having relatively large power consumption (e.g., a display) as defined above.

In operation 619, the remote control target device 110 may transmit a first state change notification message indicating that it has changed to the idle state to the second electronic device 130. The first state change notification message may include first identification information indicating that the state of the remote control target device 110 has changed from the sleep state to the idle state.

In operation 619, the second electronic device 130 may receive the first state change notification message from the remote control target device 110. The second electronic device 130 may recognize that the state of the remote control target device 110 has changed from the sleep state to the idle state by the first identification information included in the received first state change notification message.

In operation 621, the second electronic device 130 may make a pairing request to the remote control target device 110. For example, based on a remote control request for the remote control target device 110 occurring, the second electronic device 130 may transmit a connection request to the remote control target device 110 in response thereto.

Based on the connection request being transmitted to the remote control target device 110 by the second electronic device 130, in operation 623, the remote control target device 110 may perform an identification procedure for whether the second electronic device 130 has control authority for remote control.

For example, the second electronic device 130 may derive a first temporary key from the stored base key. For example, the first temporary key may be derived by the second electronic device 130 encrypting information about current time with the base key. The first temporary key may have a validity time. For example, the first temporary key may be valid for a preset time period (e.g., within several minutes) from a time generated by the second electronic device 130. Information about current time may, e.g., be information (e.g., 10:20) excluding minutes in two-digit units or less (e.g., 1 to 9 minutes) and seconds from time (e.g., 10:25:30) that may be represented in hours, minutes, and seconds. In this case, the validity time may be determined within 10 minutes. The second electronic device 130 may transmit the first temporary key to the remote control target device 110.

Based on the remote control target device 110 receiving the first temporary key from the second electronic device 130, it may derive a second temporary key using the base key stored by itself. For example, the remote control target device 110 may derive the second temporary key by encrypting information about current time with the base key. For example, the second temporary key may be obtained by the remote control target device 110 hashing information about current time corresponding to a time when the first temporary key is received from the second electronic device 130 with the base key. The second temporary key may also have a validity time. For example, the second temporary key may be valid for a preset time period (e.g., 10 minutes) from an arbitrary time after receiving the first temporary key from the second electronic device 130. Information about current time may, e.g., be information (e.g., 10 o'clock) excluding minutes and/or seconds from time (e.g., 10:25:30) that may be represented in hours, minutes, and seconds. Information about current time may, e.g., be information (e.g., 10:20) excluding minutes in two-digit units or less (e.g., 1 to 9 minutes) and seconds from time (e.g., 10:25:30) that may be represented in hours, minutes, and seconds.

The remote control target device 110 may compare the first temporary key and the second temporary key and determine whether the second electronic device 130 has control authority for remote control based on whether the two temporary keys are identical. For example, based on the first temporary key and the second temporary key being identical, the remote control target device 110 may determine that the second electronic device 130 has control authority for remote control. For example, based on the first temporary key and the second temporary key not being identical, the remote control target device 110 may determine that the second electronic device 130 does not have control authority for remote control.

Based on the remote control target device 110 determining that the second electronic device 130 has control authority for remote control, in operation 625, it may transmit a message approving registration to the second electronic device 130.

Based on verification that the second electronic device 130 has control authority being completed, the remote control target device 110 and the second electronic device 130 may perform an operation for performing remote control in operations 627 to 633, which may be substantially the same as operations 527 to 533, respectively, described with reference to FIG. 5, so detailed description thereof is omitted.

FIGS. 7A and 7B are views exemplarily illustrating an operation in which an electronic device (e.g., the first electronic device 120 or the second electronic device 130 of FIG. 1) obtains connection information or authority information.

In the description with reference to FIGS. 7A and 7B to be described below, it is assumed that the connection information referenced in FIG. 2 or FIG. 6 is obtained by the electronic devices 120, 130, but obtaining the authority information referenced in FIG. 4 may also be proposed in the same manner.

Referring to FIG. 7A, the remote control target device 110 may generate a QR code 710 corresponding to an identifier including the remote control connection information or authority information. The remote control target device 110 may output the generated QR code 710 through a display. For example, the remote control target device 110 may output the QR code 710 through the display in response to a physical button 720 provided on an externally identifiable portion such as a front panel being pressed by the user. Unlike what is illustrated, the remote control target device 110 may transmit information about the generated QR code to an external display device so that the generated QR code may be displayed on the external display device (e.g., a monitor or a screen).

For example, the electronic devices 120, 130 may obtain identification information (e.g., MAC address), a temporary key, or a wakeup key by capturing the QR code 710 displayed on the remote control target device 110 or the external display device (e.g., a monitor or a screen) (see FIG. 2). For example, the electronic devices 120, 130 may obtain identification information (e.g., MAC address) capable of identifying the remote control target device 110, a wakeup key, or a base key by capturing the QR code 710 displayed on the remote control target device 110 or the external display device (e.g., a monitor or a screen) (see FIG. 6). The electronic devices 120, 130 may display the obtained connection information on a display 730.

Referring to FIG. 7B, a QR sticker 740 (or an NFC sticker) may be attached to an externally identifiable portion such as a front panel of the remote control target device 110. The QR sticker 740 (or the NFC sticker) may include the connection information. The electronic devices 120, 130 may obtain the connection information by capturing (or tagging) the QR sticker 740 (or the NFC sticker) attached to the remote control target device 110. The connection information may, e.g., include identification information (e.g., MAC address), a temporary key, or a wakeup key (see FIG. 2). The connection information may, e.g., include identification information (e.g., MAC address) capable of identifying the remote control target device 110, a wakeup key, or a base key (see FIG. 6). The electronic devices 120, 130 may display the obtained connection information on a display 750.

FIG. 8 is a block diagram illustrating a remote control target device 801 (e.g., the display device 110 of FIG. 1) (hereinafter referred to as ‘remote control target device 801’) in a network environment 800 according to various embodiments.

Referring to FIG. 8, in the network environment 800, the remote control target device 801 may communicate with an electronic device 803 through a first network 898 (e.g., a short-range wireless communication network), or communicate with at least one of an electronic device 805 or a server 807 through a second network 896 (e.g., a long-range wireless communication network). According to an example, the remote control target device 801 may communicate with the electronic device 805 through the server 807. According to an example, the remote control target device 801 may include a processor 810, a memory 820, an audio module 840, a video module 850, a sensor module 860, a power management module 870, an input module 882, an interface 884, a connecting terminal 886, or a communication module 890. In some examples, at least one of these components (e.g., the input module 882) may be omitted from the remote control target device 801, or one or more other components may be added. In an example, some of these components may be integrated into one component.

The processor 810 may execute, for example, software (e.g., the program 830) to control at least one other component (e.g., a hardware or software component) of the remote control target device 801 coupled with the processor 810, and may perform various data processing or computation. According to an example, as at least part of the data processing or computation, the processor 810 may store a command or data received from another component (e.g., the sensor module 860 or the communication module 890) in volatile memory 822, process the command or the data stored in the volatile memory 822, and store resulting data in non-volatile memory 824. According to an example, the processor 810 may include a main processor 812 (e.g., a central processing unit (CPU) or an application processor (AP)), or an auxiliary processor 814 (e.g., a graphics processing unit (GPU), a neural processing unit (NPU), an image signal processor (ISP), a sensor hub processor, or a communication processor (CP)) that is operable independently from, or in conjunction with, the main processor 812. For example, in case that the remote control target device 801 includes the main processor 812 and the auxiliary processor 814, the auxiliary processor 814 may be configured to use lower power than the main processor 812 or to be specified for a designated function. The auxiliary processor 814 may be implemented as separate from, or as part of the main processor 812.

The auxiliary processor 814 may control at least some of functions or states related to at least one component (e.g., the sensor module 860 or the communication module 890) among the components of the remote control target device 801, instead of the main processor 812 while the main processor 812 is in an inactive (e.g., sleep) state, or together with the main processor 812 while the main processor 812 is in an active state (e.g., executing an application). According to an example, the auxiliary processor 814 (e.g., an image signal processor or a communication processor) may be implemented as part of another component (e.g., the communication module 890) functionally related to the auxiliary processor 814. According to an example, the auxiliary processor 814 (e.g., the neural processing unit) may include a hardware structure specified for artificial intelligence model processing. The artificial intelligence model may be generated via machine learning. Such learning may be performed, e.g., by the remote control target device 801 where the artificial intelligence is performed or via a separate server (e.g., the server 807). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted Boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 820 may store various data used by at least one component (e.g., the processor 810 or the sensor module 860) of the remote control target device 801. The various data may include, for example, software (e.g., the program 830) and input data or output data for a command related thereto. The memory 820 may include the volatile memory 822 or the non-volatile memory 824.

The program 830 may be stored in the memory 820 as software, and may include, for example, an operating system (OS) 836, middleware 834, or an application 832.

The input module 882 may receive a command or data to be used by other component (e.g., the processor 810) of the remote control target device 801, from the outside (e.g., a user) of the remote control target device 801. The input module 882 may include, for example, a microphone, a mouse, a keyboard, keys (e.g., buttons), or a digital pen (e.g., a stylus pen).

The audio module 840 may include a sound processing module 842 or a sound output module 844. The sound output module 844 may output audio signals to the outside of the remote control target device 801. The sound output module 844 may include, e.g., a speaker. The speaker may be used for general purposes, such as playing multimedia or playing record. The sound processing module 842 may convert a sound into an electrical signal and vice versa. According to an example, the audio module 840 may obtain the sound via the input module 882, or output the sound via the sound output module 844 or a headphone of an external electronic device (e.g., the electronic device 803) directly (e.g., wiredly) or wirelessly coupled with the remote control target device 801.

The image module 850 may include an image processing module 852 or an image output module 854. The image processing module 852 may output video signals to the outside of the remote control target device 801. The image output module 854 may include, e.g., a display and/or a light projector. The light projector may convert electrical video signals into optical signals and output them. The image processing module 852 may convert an image into an electrical signal, or may convert an electrical signal into an image. According to an example, the image module 850 may obtain the image through the input module 882, or output the image through the image output module 854 or an external electronic device (e.g., the electronic device 803) directly or wirelessly connected with the remote control target device 801. The image module 850 may include, for example, a display, a hologram device, or a projector and control circuitry to control a corresponding one of the display, hologram device, and projector.

The sensor module 860 may detect an operation state (e.g., power or temperature) of the remote control target device 801 or an external environmental state (e.g., the user's state), and then generate an electrical signal or data value corresponding to the detected state. According to an example, the sensor module 860 may include, e.g., a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 884 may support one or more specified protocols to be used for the remote control target device 801 to be coupled with the external electronic device (e.g., the electronic device 803) directly (e.g., wiredly) or wirelessly. The interface 884 may include, e.g., a high definition multimedia interface (HDMI), a universal serial bus (USB) interface, a secure digital (SD) card interface, or an audio interface (e.g., Bixby).

The connecting terminal 886 may include a connector via which the remote control target device 801 may be physically connected with the external electronic device (e.g., the electronic device 803). According to an example, the connecting terminal 886 may include, for example, a HDMI connector, a USB connector, a SD card connector, or an audio connector (e.g., a headphone connector).

The power management module 870 may manage power supplied to the remote control target device 801. According to an embodiment, the power management module 870 may be implemented as at least part of, for example, a power management integrated circuit (PMIC).

The communication module 890 may support establishing a direct (e.g., wired) communication channel or a wireless communication channel between the remote control target device 801 and the external electronic device (e.g., the electronic device 803, the electronic device 805, or the server 807) and performing communication via the established communication channel. The communication module 890 may include one or more communication processors that are operable independently from the processor 810 (e.g., the application processor (AP)) and supports a direct (e.g., wired) communication or a wireless communication. According to an example, the communication module 890 may include a wireless communication module 892 (e.g., a cellular communication module, a short-range wireless communication module, or a global navigation satellite system (GNSS) communication module) or a wired communication module 894 (e.g., a local area network (LAN) communication module or a power line communication (PLC) module). A corresponding one of these communication modules may communicate with the external electronic device 805 via a first network 898 (e.g., a short-range communication network, such as Bluetooth™, wireless-fidelity (Wi-Fi) direct, or infrared data association (IrDA)) or a second network 896 (e.g., a long-range communication network, such as a legacy cellular network, a 5G network, a next-generation communication network, the Internet, or a computer network (e.g., local area network (LAN) or wide area network (WAN)). These various types of communication modules may be implemented as a single component (e.g., a single chip), or may be implemented as multi components (e.g., multi chips) separate from each other. The wireless communication module 892 may identify or authenticate the remote control target device 801 in a communication network, such as the first network 898 or the second network 896, using subscriber information (e.g., international mobile subscriber identity (IMSI)).

The wireless communication module 892 may support a 5G network, after a 4G network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 892 may support a high-frequency band (e.g., the mmWave band) to achieve, e.g., a high data transmission rate. The wireless communication module 892 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 892 may support various requirements specified in the remote control target device 801, an external electronic device (e.g., the electronic device 805), or a network system (e.g., the second network 896). According to an embodiment, the wireless communication module 892 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an example, commands or data may be transmitted or received between the remote control target device 801 and the external electronic device 805 via the server 807 coupled with the second network 896. The external electronic devices 803 or 805 each may be a device of the same or a different type from the remote control target device 801. According to an example, all or some of operations to be executed at the remote control target device 801 may be executed at one or more of the external electronic devices 803, 805, or 807. For example, if the remote control target device 801 should perform a function or a service automatically, or in response to a request from a user or another device, the remote control target device 801, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the remote control target device 801. The remote control target device 801 may provide the outcome, with or without further processing of the outcome, as at least part of a reply to the request. To that end, a cloud computing, distributed computing, mobile edge computing (MEC), or client-server computing technology may be used, for example. The remote control target device 801 may provide an ultra-low latency service using, e.g., distributed computing or mobile edge computing. In an embodiment, the external electronic device 805 may include an internet-of-things (IoT) device. The server 807 may be an intelligent server using machine learning and/or a neural network. According to an example, the external electronic device 805 or the server 807 may be included in the second network 896. The remote control target device 801 may be applied to intelligent services (e.g., smart home, smart city, smart car, or healthcare) based on 5G communication technology and IoT-related technology.

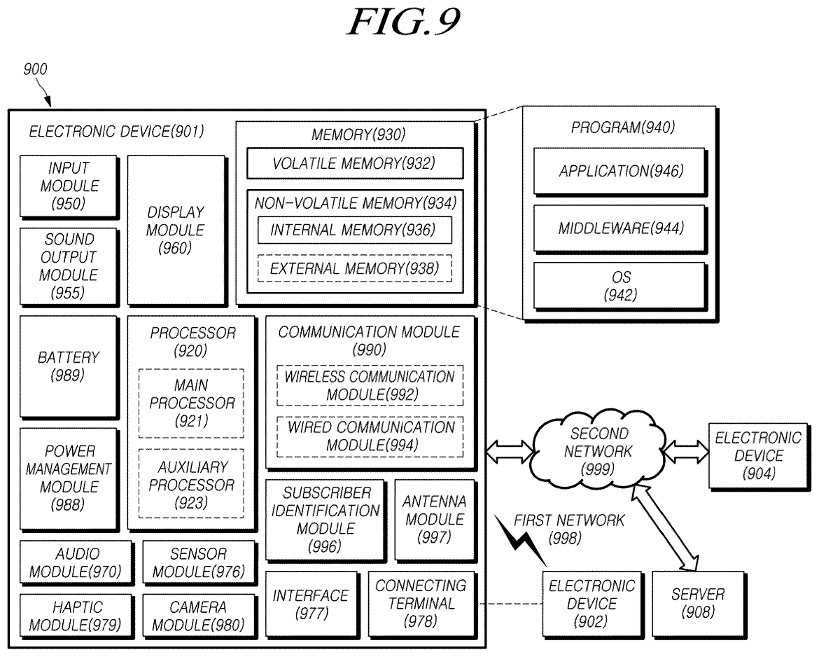

FIG. 9 is a block diagram illustrating an electronic device 901 (e.g., the first electronic device 120 or the second electronic device 130 of FIG. 1) in a network environment 900 according to various embodiments.

Referring to FIG. 9, the electronic device 901 in the network environment 900 may communicate with at least one of an electronic device 902 via a first network 998 (e.g., a short-range wireless communication network), or an electronic device 904 or a server 908 via a second network 999 (e.g., a long-range wireless communication network). According to an embodiment, the electronic device 901 may communicate with the electronic device 904 via the server 908. According to an embodiment, the electronic device 901 may include a processor 920, memory 930, an input module 950, a sound output module 955, a display module 960, an audio module 970, a sensor module 976, an interface 977, a connecting terminal 978, a haptic module 979, a camera module 980, a power management module 988, a battery 989, a communication module 990, a subscriber identification module (SIM) 996, or an antenna module 997. In an embodiment, at least one (e.g., the connecting terminal 978) of the components may be omitted from the electronic device 901, or one or more other components may be added in the electronic device 901. According to an embodiment, some (e.g., the sensor module 976, the camera module 980, or the antenna module 997) of the components may be integrated into a single component (e.g., the display module 960).

The processor 920 may execute, for example, software (e.g., the program 940) to control at least one other component (e.g., a hardware or software component) of the electronic device 901 coupled with the processor 920, and may perform various data processing or computation. According to one embodiment, as at least part of the data processing or computation, the processor 920 may store a command or data received from another component (e.g., the sensor module 976 or the communication module 990) in volatile memory 932, process the command or the data stored in the volatile memory 932, and store resulting data in non-volatile memory 934. According to an embodiment, the processor 920 may include a main processor 921 (e.g., a central processing unit (CPU) or an application processor (AP)), or a auxiliary processor 923 (e.g., a graphics processing unit (GPU), a neural processing unit (NPU), an image signal processor (ISP), a sensor hub processor, or a communication processor (CP)) that is operable independently from, or in conjunction with, the main processor 921. For example, in case that the electronic device 901 includes the main processor 921 and the auxiliary processor 923, the auxiliary processor 923 may be configured to use lower power than the main processor 921 or to be specified for a designated function. The auxiliary processor 923 may be implemented as separate from, or as part of the main processor 921.

The auxiliary processor 923 may control at least some of functions or states related to at least one component (e.g., the display module 960, the sensor module 976, or the communication module 990) among the components of the electronic device 901, instead of the main processor 921 while the main processor 921 is in an inactive (e.g., sleep) state, or together with the main processor 921 while the main processor 921 is in an active state (e.g., executing an application). According to an embodiment, the auxiliary processor 923 (e.g., an image signal processor or a communication processor) may be implemented as part of another component (e.g., the camera module 980 or the communication module 990) functionally related to the auxiliary processor 923. According to an embodiment, the auxiliary processor 923 (e.g., the neural processing unit) may include a hardware structure specified for artificial intelligence model processing. The artificial intelligence model may be generated via machine learning. Such learning may be performed, e.g., by the electronic device 901 where the artificial intelligence is performed or via a separate server (e.g., the server 908). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted Boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 930 may store various data used by at least one component (e.g., the processor 920 or the sensor module 976) of the electronic device 901. The various data may include, for example, software (e.g., the program 940) and input data or output data for a command related thereto. The memory 930 may include the volatile memory 932 or the non-volatile memory 934.

The program 940 may be stored in the memory 930 as software, and may include, for example, an operating system (OS) 942, middleware 944, or an application 946.

The input module 950 may receive a command or data to be used by other component (e.g., the processor 920) of the electronic device 901, from the outside (e.g., a user) of the electronic device 901. The input module 950 may include, for example, a microphone, a mouse, a keyboard, keys (e.g., buttons), or a digital pen (e.g., a stylus pen).

The sound output module 955 may output sound signals to the outside of the electronic device 901. The sound output module 955 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 960 may visually provide information to the outside (e.g., a user) of the electronic device 901. The display module 960 may include, for example, a display, a hologram device, or a projector and control circuitry to control a corresponding one of the display, hologram device, and projector. According to an embodiment, the display module 960 may include a touch sensor configured to detect a touch, or a pressure sensor configured to measure the intensity of a force generated by the touch.

The audio module 970 may convert a sound into an electrical signal and vice versa. According to an embodiment, the audio module 970 may obtain the sound via the input module 950, or output the sound via the sound output module 955 or a headphone of an external electronic device (e.g., an electronic device 902) directly (e.g., wiredly) or wirelessly coupled with the electronic device 901.

The sensor module 976 may detect an operation state (e.g., power or temperature) of the electronic device 901 or an external environmental state (e.g., the user's state), and then generate an electrical signal or data value corresponding to the detected state. According to an embodiment, the sensor module 976 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 977 may support one or more specified protocols to be used for the electronic device 901 to be coupled with the external electronic device (e.g., the electronic device 902) directly (e.g., wiredly) or wirelessly. According to an embodiment, the interface 977 may include, for example, a high definition multimedia interface (HDMI), a universal serial bus (USB) interface, a secure digital (SD) card interface, or an audio interface.

A connecting terminal 978 may include a connector via which the electronic device 901 may be physically connected with the external electronic device (e.g., the electronic device 902). According to an embodiment, the connecting terminal 978 may include, for example, a HDMI connector, a USB connector, a SD card connector, or an audio connector (e.g., a headphone connector).

The haptic module 979 may convert an electrical signal into a mechanical stimulus (e.g., a vibration or motion) or electrical stimulus which may be recognized by a user via his tactile sensation or kinesthetic sensation. According to an embodiment, the haptic module 979 may include, for example, a motor, a piezoelectric element, or an electric stimulator.

The camera module 980 may capture a still image or moving images. According to an embodiment, the camera module 980 may include one or more lenses, image sensors, image signal processors, or flashes.

The power management module 988 may manage power supplied to the electronic device 901. According to an embodiment, the power management module 988 may be implemented as at least part of, for example, a power management integrated circuit (PMIC).

The battery 989 may supply power to at least one component of the electronic device 901. According to an embodiment, the battery 989 may include, for example, a primary cell which is not rechargeable, a secondary cell which is rechargeable, or a fuel cell.

The communication module 990 may support establishing a direct (e.g., wired) communication channel or a wireless communication channel between the electronic device 901 and the external electronic device (e.g., the electronic device 902, the electronic device 904, or the server 908) and performing communication via the established communication channel. The communication module 990 may include one or more communication processors that are operable independently from the processor 920 (e.g., the application processor (AP)) and supports a direct (e.g., wired) communication or a wireless communication. According to an embodiment, the communication module 990 may include a wireless communication module 992 (e.g., a cellular communication module, a short-range wireless communication module, or a global navigation satellite system (GNSS) communication module) or a wired communication module 994 (e.g., a local area network (LAN) communication module or a power line communication (PLC) module). A corresponding one of these communication modules may communicate with the external electronic device 904 via a first network 998 (e.g., a short-range communication network, such as Bluetooth™, wireless-fidelity (Wi-Fi) direct, or infrared data association (IrDA)) or a second network 999 (e.g., a long-range communication network, such as a legacy cellular network, a 5G network, a next-generation communication network, the Internet, or a computer network (e.g., local area network (LAN) or wide area network (WAN)). These various types of communication modules may be implemented as a single component (e.g., a single chip), or may be implemented as multi components (e.g., multi chips) separate from each other. The wireless communication module 992 may identify or authenticate the electronic device 901 in a communication network, such as the first network 998 or the second network 999, using subscriber information (e.g., international mobile subscriber identity (IMSI)) stored in the subscriber identification module 996.

The wireless communication module 992 may support a 5G network, after a 4G network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 992 may support a high-frequency band (e.g., the mmWave band) to achieve, e.g., a high data transmission rate. The wireless communication module 992 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 992 may support various requirements specified in the electronic device 901, an external electronic device (e.g., the electronic device 904), or a network system (e.g., the second network 999). According to an embodiment, the wireless communication module 992 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 997 may transmit or receive a signal or power to or from the outside (e.g., the external electronic device). According to an embodiment, the antenna module 997 may include one antenna including a radiator formed of a conductor or conductive pattern formed on a substrate (e.g., a printed circuit board (PCB)). According to an embodiment, the antenna module 997 may include a plurality of antennas (e.g., an antenna array). In this case, at least one antenna appropriate for a communication scheme used in a communication network, such as the first network 998 or the second network 999, may be selected from the plurality of antennas by, e.g., the communication module 990. The signal or the power may then be transmitted or received between the communication module 990 and the external electronic device via the selected at least one antenna. According to an embodiment, other parts (e.g., radio frequency integrated circuit (RFIC)) than the radiator may be further formed as part of the antenna module 997.

According to various embodiments, the antenna module 997 may form a mmWave antenna module. According to an embodiment, the mmWave antenna module may include a printed circuit board, a RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 901 and the external electronic device 904 via the server 908 coupled with the second network 999. The external electronic devices 902 or 904 each may be a device of the same or a different type from the electronic device 901. According to an embodiment, all or some of operations to be executed at the electronic device 901 may be executed at one or more of the external electronic devices 902, 904, or 908. For example, if the electronic device 901 should perform a function or a service automatically, or in response to a request from a user or another device, the electronic device 901, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 901. The electronic device 901 may provide the outcome, with or without further processing of the outcome, as at least part of a reply to the request. To that end, a cloud computing, distributed computing, mobile edge computing (MEC), or client-server computing technology may be used, for example. The electronic device 901 may provide ultra low-latency services using, e.g., distributed computing or mobile edge computing. In another embodiment, the external electronic device 904 may include an Internet-of-things (IoT) device. The server 908 may be an intelligent server using machine learning and/or a neural network. According to an embodiment, the external electronic device 904 or the server 908 may be included in the second network 999. The electronic device 901 may be applied to intelligent services (e.g., smart home, smart city, smart car, or healthcare) based on 5G communication technology or IoT-related technology.

The electronic device according to various embodiments of the disclosure may be one of various types of electronic devices. The electronic devices may include, for example, a portable communication device (e.g., a smartphone), a computer device, a portable multimedia device, a portable medical device, a camera, a wearable device, or a home appliance. The electronic devices according to an embodiment of the disclosure are not limited to the above-described devices.

For example, the electronic device 120 may include a communication circuit 990. The electronic device 120 may include a memory 930 including one or more storage media storing instructions. The electronic device 120 may include at least one processor 920 including a processing circuit. Based on the instructions being executed individually or collectively by the at least one processor 920, the electronic device 120 may perform a registration procedure corresponding to obtaining control authority for a first device 110 based on characteristic information about the first device 110. Based on the instructions being executed individually or collectively by the at least one processor 920, the electronic device 120 may control the communication circuit 990 to transmit data for obtaining control authority for the first device 110 to a second device 130.

For example, the characteristic information about the first device 110 may include at least one of identification information of the first device 110, a first temporary key (also referred to as a pairing key) having a validity time, or a wakeup key.

For example, the data for obtaining the control authority may include at least one of the identification information of the first device 110, a second temporary key having a validity time, or the wakeup key.

For example, a state of the first device 110 may be one of a sleep state, an idle state, or an active state.

For example, based on the instructions being executed individually or collectively by the at least one processor 920, the electronic device 120 may obtain the identification information of the first device 110, a first pairing key having a validity time, or a wakeup key.

For example, based on the instructions being executed individually or collectively by the at least one processor 920, the electronic device 120 may obtain a session key corresponding to connection authority verification for the first device 110 based on being connected to the first device 110 corresponding to the obtained identification information based on the obtained first temporary key.

For example, based on the instructions being executed individually or collectively by the at least one processor 920, the electronic device 120 may decrypt an encrypted base key received from the first device 110 based on the obtained session key to obtain the base key.

For example, based on the instructions being executed individually or collectively by the at least one processor 920, the electronic device 120 may obtain at least one of the identification information of the first device 110, a first temporary key having a validity time, or a wakeup key from an image capturing a first identifier displayed on the first device 110.

For example, based on the instructions being executed individually or collectively by the at least one processor 920, the electronic device 120 may control the communication circuit 990 to transmit a first encrypted value (also referred to as a first hash value) obtained by encrypting a first temporary value received from the first device 110 with the obtained first temporary key to the first device 110 for connection to the first device 110.

For example, based on the instructions being executed individually or collectively by the at least one processor 920, the electronic device 120 may obtain the session key based on a set algorithm based on being connected to the first device 110.

For example, based on the instructions being executed individually or collectively by the at least one processor 920, the electronic device 120 may control the communication circuit 990 to transmit a second encrypted value (also referred to as a second hash value) obtained by encrypting a second temporary value obtained from a beacon message received from the first device 110 in the sleep state with the obtained wakeup key to the first device 110 in the sleep state.

For example, based on the instructions being executed individually or collectively by the at least one processor 920, the electronic device 120 may control the communication circuit 990 to receive first identification information from the first device 110 in response to the first device 110 changing from the sleep state to the idle state.

For example, based on the instructions being executed individually or collectively by the at least one processor 920, the electronic device 120 may control the communication circuit 990 to transmit a third encrypted value (also referred to as a third hash value) obtained by encrypting a third temporary value received from the first device 110 with the obtained session key to the first device 110 in the idle state.

For example, based on the instructions being executed individually or collectively by the at least one processor 920, the electronic device 120 may control the communication circuit 990 to receive second identification information in response to the first device 110 changing from the idle state to the active state.

For example, based on the instructions being executed individually or collectively by the at least one processor 920, the electronic device 120 may remotely control the first device 110 based on the received second identification information.

For example, based on the instructions being executed individually or collectively by the at least one processor 920, the electronic device 120 may obtain a second temporary key having a validity time by encrypting information corresponding to current time with the obtained base key based on receiving a request corresponding to control authority sharing.

For example, based on the instructions being executed individually or collectively by the at least one processor 920, the electronic device 120 may control the communication circuit 990 to provide the obtained identification information, the obtained wakeup key, and the obtained second temporary key to the second device 130.

For example, based on the instructions being executed individually or collectively by the at least one processor 920, the electronic device 120 may control to output a screen including a second identifier corresponding to provision of the obtained identification information, the obtained wakeup key, and the obtained second temporary key to the second device 130.

For example, a method of operating an electronic device 120 may include performing a registration procedure corresponding to obtaining control authority for a first device 110 based on characteristic information about the first device 110. The method may include controlling the communication circuit 990 to transmit data for obtaining control authority for the first device 110 to a second device 130.

For example, the characteristic information about the first device 110 may include at least one of identification information of the first device 110, a first pairing key having a validity time, or a wakeup key.

For example, the data for obtaining the control authority may include at least one of the identification information of the first device 110, a second temporary key having a validity time, or the wakeup key.

For example, a state of the first device 110 may be one of a sleep state, an idle state, or an active state.

For example, performing the registration procedure may include obtaining the identification information of the first device 110, a first pairing key having a validity time, or a wakeup key.

For example, performing the registration procedure may include obtaining a session key corresponding to connection authority verification for the first device 110 based on being connected to the first device 110 corresponding to the obtained identification information based on the obtained first temporary key.

For example, performing the registration procedure may include decrypting an encrypted base key received from the first device 110 based on the obtained session key to obtain the base key.

For example, the obtaining may include obtaining at least one of the identification information of the first device 110, a first temporary key having a validity time, or a wakeup key from an image capturing a first identifier displayed on the first device 110.

For example, connecting the first device 110 may include controlling the communication circuit 990 to transmit a first hash value obtained by encrypting a first temporary value received from the first device 110 with the obtained first temporary key to the first device 110 for connection to the first device 110.

For example, obtaining the session key may include obtaining the session key based on a set algorithm based on being connected to the first device 110.

For example, the method may include controlling the communication circuit 990 to transmit a second hash value obtained by encrypting a second temporary value obtained from a beacon message received from the first device 110 in the sleep state with the obtained wakeup key to the first device 110 in the sleep state.

For example, the method may include controlling the communication circuit 990 to receive first identification information from the first device 110 in response to the first device 110 changing from the sleep state to the idle state.

For example, the method may include controlling the communication circuit 990 to transmit a third hash value obtained by encrypting a third temporary value received from the first device 110 with the obtained session key to the first device 110 in the idle state.

For example, the method may include controlling the communication circuit 990 to receive second identification information in response to the first device 110 changing from the idle state to the active state.

For example, the method may include remotely controlling the first device 110 based on the received second identification information.

For example, transmitting the authority data to the second device 130 may include obtaining a second temporary key having a validity time by encrypting information corresponding to current time with the obtained base key based on receiving a request corresponding to control authority sharing.

For example, transmitting the authority data to the second device 130 may include controlling the communication circuit 990 to provide the obtained identification information, the obtained wakeup key, and the obtained second temporary key to the second device 130.

For example, transmitting the authority data to the second device 130 may include controlling to output a screen including a second identifier corresponding to provision of the obtained identification information, the obtained wakeup key, and the obtained second temporary key to the second device 130.

For example, a recording medium may store computer-readable instructions. The instructions may, based on being executed by at least a portion of at least one processor 920 included in an electronic device 120, cause the electronic device 120 to perform at least one operation. The at least one operation may include performing a registration procedure corresponding to obtaining control authority for a first device 110 based on characteristic information about the first device 110. The at least one operation may include controlling the communication circuit 990 to transmit data for obtaining control authority for the first device 110 to a second device 130.

For example, the remote control target device 110 may include a communication circuit 890. The remote control target device 110 may include a memory 820 including one or more storage media storing instructions. The remote control target device 110 may include at least one processor 810 including a processing circuit. The instructions may, based on being executed individually or collectively by the at least one processor 810, cause the remote control target device 110 to perform at least one operation. The at least one operation may include performing a registration procedure for granting control authority to a first device 120. The at least one operation may include controlling a power state in response to a request from the first device 120 to which the control authority has been granted. The at least one operation may include performing remote control according to a request from the first device 120 to which the control authority has been granted. Performing the registration procedure may include providing identification information, a first pairing key having a validity time, or a wakeup key to the first device 120. Performing the registration procedure may include connecting the first device 120 using the first temporary key. Performing the registration procedure may include obtaining a first session key to be used for connection authority verification for the first device 120 based on connection to the first device 120 being successful. Performing the registration procedure may include transmitting a base key encrypted by the obtained first session key to the first device 120.

For example, the instructions may, based on being executed individually or collectively by the at least one processor 810, cause the remote control target device 110 to perform displaying a first identifier (e.g., a quick response (QR) code) including information about the identification information, the first temporary key, and the wakeup key on a display.

For example, the instructions may, based on being executed individually or collectively by the at least one processor 810, cause the remote control target device 110 to perform transmitting a first temporary value to the first device 120.

For example, the instructions may, based on being executed individually or collectively by the at least one processor 810, cause the remote control target device 110 to perform receiving a first hash value from the first device 120.

For example, the instructions may, based on being executed individually or collectively by the at least one processor 810, cause the remote control target device 110 to perform granting control authority to the first device 120 in response to a temporary value obtained by decrypting the received first hash value with the first temporary key matching the first temporary value.

For example, the instructions may, based on being executed individually or collectively by the at least one processor 810, cause the remote control target device 110 to perform obtaining the first session key based on a specific algorithm according to successful connection to the first device 120.

For example, the instructions may, based on being executed individually or collectively by the at least one processor 810, cause the remote control target device 110 to perform transmitting a beacon message including a second temporary value in a sleep state.

For example, the instructions may, based on being executed individually or collectively by the at least one processor 810, cause the remote control target device 110 to perform receiving a second hash value from the first device 120.

For example, the instructions may, based on being executed individually or collectively by the at least one processor 810, cause the remote control target device 110 to perform changing a state from the sleep state to an idle state based on a temporary value obtained by decrypting the received second hash value with the wakeup key matching the second temporary value.

For example, the instructions may, based on being executed individually or collectively by the at least one processor 810, cause the remote control target device 110 to perform transmitting first identification information indicating that the state has changed to the idle state to the first device 120.

For example, the instructions may, based on being executed individually or collectively by the at least one processor 810, cause the remote control target device 110 to perform transmitting a third temporary value.

For example, the instructions may, based on being executed individually or collectively by the at least one processor 810, cause the remote control target device 110 to perform receiving a third hash value from the first device 120.

For example, the instructions may, based on being executed individually or collectively by the at least one processor 810, cause the remote control target device 110 to perform changing a state from the idle state to an active state based on a temporary value obtained by decrypting the received third hash value with the first session key matching the third temporary value.

For example, the instructions may, based on being executed individually or collectively by the at least one processor 810, cause the remote control target device 110 to perform transmitting second identification information indicating that the state has changed to the active state to the first device 120.

For example, the instructions may, based on being executed individually or collectively by the at least one processor 810, cause the remote control target device 110 to perform performing remote control according to a request from the first device 120.

For example, the instructions may, based on being executed individually or collectively by the at least one processor 810, cause the remote control target device 110 to perform transmitting a beacon message including a fourth temporary value in a sleep state.

For example, the instructions may, based on being executed individually or collectively by the at least one processor 810, cause the remote control target device 110 to perform receiving a fourth hash value from a second device 130.

For example, the instructions may, based on being executed individually or collectively by the at least one processor 810, cause the remote control target device 110 to perform changing a state from the sleep state to an idle state based on a temporary value obtained by decrypting the received fourth hash value with the wakeup key matching the fourth temporary value.

For example, the instructions may, based on being executed individually or collectively by the at least one processor 810, cause the remote control target device 110 to perform transmitting third identification information indicating that the state has changed to the idle state to the second device 130.

For example, the second device 130 may be an electronic device that has received control authority shared from the first electronic device 120.

For example, the instructions may, based on being executed individually or collectively by the at least one processor 810, cause the remote control target device 110 to perform receiving a second temporary key having a validity time from the second device 130.

For example, the instructions may, based on being executed individually or collectively by the at least one processor 810, cause the remote control target device 110 to perform obtaining a third temporary key by encrypting information about current time with the base key.

For example, the instructions may, based on being executed individually or collectively by the at least one processor 810, cause the remote control target device 110 to perform obtaining a second session key to be used for connection authority verification for the second device 130 based on the received second temporary key and the obtained third temporary key matching.

For example, the instructions may, based on being executed individually or collectively by the at least one processor 810, cause the remote control target device 110 to perform transmitting the base key encrypted by the obtained second session key to the second device 130.

For example, the electronic device 130 may include a communication circuit 990. The electronic device 130 may include a memory 930 including one or more storage media storing instructions. The electronic device 130 may include at least one processor 920 including a processing circuit. The instructions may, based on being executed individually or collectively by the at least one processor 920, cause the electronic device 130 to perform at least one operation. The at least one operation may include receiving control authority for a remote control target device 110 shared from another electronic device 120 that has obtained control authority for the remote control target device 110. The at least one operation may include remotely controlling a power state of the remote control target device 110 in a sleep state based on the shared control authority. The at least one operation may include remotely controlling the remote control target device 110 in an idle state or an active state based on the shared control authority. Receiving the control authority shared may include obtaining identification information of the remote control target device 110. a wakeup key, and a first temporary key having a validity time provided by the other electronic device 120 in response to a control authority sharing request. The first temporary key may be generated by encrypting information about current time with a base key.

For example, the instructions may, based on being executed individually or collectively by the at least one processor 920, cause the electronic device 130 to perform obtaining a first temporary value from a beacon message received from the remote control target device 110 in the sleep state using the obtained identification information.

For example, the instructions may, based on being executed individually or collectively by the at least one processor 920, cause the electronic device 130 to perform transmitting a first hash value obtained by encrypting the obtained first temporary value with the obtained wakeup key to the remote control target device 110 in the sleep state.

For example, the instructions may, based on being executed individually or collectively by the at least one processor 920, cause the electronic device 130 to perform receiving first identification information indicating that a state has changed from the sleep state to the idle state from the remote control target device 110.

For example, the instructions may, based on being executed individually or collectively by the at least one processor 920, cause the electronic device 130 to perform transmitting the first temporary key to the remote control target device 110 in the idle state or the active state.

For example, the instructions may, based on being executed individually or collectively by the at least one processor 920, cause the electronic device 130 to perform obtaining a second session key according to verification of the control authority sharing based on the first temporary key based on connection to the remote control target device 110 being successful.

For example, the instructions may, based on being executed individually or collectively by the at least one processor 920, cause the electronic device 130 to perform receiving an encrypted base key from the remote control target device 110.

For example, the instructions may, based on being executed individually or collectively by the at least one processor 920, cause the electronic device 130 to perform obtaining a base key by decrypting the encrypted base key using the obtained session key.

For example, the instructions may, based on being executed individually or collectively by the at least one processor 920, cause the electronic device 130 to perform obtaining the session key based on a specific algorithm according to successful connection to the remote control target device 110.

According to an aspect of the disclosure, an electronic device includes a communication circuit; memory including one or more storage media storing instructions; and at least one processor including a processing circuit, wherein based on the instructions being executed individually or collectively by the at least one processor, the electronic device is configured to: perform a registration procedure corresponding to obtaining control authority for a first device based on characteristic information about the first device, and control the communication circuit to transmit, to a second device, data for obtaining the control authority for the first device.

The characteristic information about the first device comprises at least one of identification information of the first device, a first temporary key having a validity time, or a wakeup key, wherein the data for obtaining the control authority comprises at least one of the identification information of the first device, a second temporary key having a validity time, or the wakeup key, and wherein a state of the first device is one of a sleep state, an idle state, or an active state.

Based on the instructions being executed individually or collectively by the at least one processor, the electronic device is configured to: obtain identification information of the first device, a first temporary key having a validity time, or a wakeup key, based on being connected to the first device corresponding to the obtained identification information based on the obtained first temporary key, obtain a session key corresponding to connection authority verification for the first device, and decrypt an encrypted base key received from the first device based on the obtained session key to obtain a decrypted base key.

Based on the instructions being executed individually or collectively by the at least one processor, the electronic device is configured to obtain at least one of identification information of the first device, a first temporary key having a validity time, or a wakeup key from an image capturing a first identifier displayed on the first device.

Based on the instructions being executed individually or collectively by the at least one processor, the electronic device is configured to: obtain a first encrypted value by encrypting a first temporary value received from the first device with the obtained first temporary key, and control the communication circuit to transmit the obtained first encrypted value to the first device for connection to the first device.

Based on the instructions being executed individually or collectively by the at least one processor, the electronic device is configured to obtain the session key based on a set algorithm based on being connected to the first device.

Based on the instructions being executed individually or collectively by the at least one processor, the electronic device is configured to: obtain a second temporary value from a beacon message received from the first device in the sleep state, obtain a second encrypted value by encrypting the obtained second temporary value with the obtained wakeup key, control the communication circuit to transmit the obtained second encrypted value to the first device in the sleep state, and control the communication circuit to receive first identification information from the first device in response to the first device changing from the sleep state to the idle state.

Based on the instructions being executed individually or collectively by the at least one processor, the electronic device is configured to: obtain a third encrypted value by encrypting a third temporary value received from the first device with the obtained session key, control the communication circuit to transmit the obtained third encrypted value to the first device in the idle state, control the communication circuit to receive second identification information in response to the first device changing from the idle state to the active state, and remotely control the first device based on the received second identification information.

Based on the instructions being executed individually or collectively by the at least one processor, the electronic device is configured to: based on receiving a request corresponding to control authority sharing, encrypt information corresponding to a current time with the obtained base key to obtain the second temporary key having the validity time, and control the communication circuit to provide the obtained identification information, the obtained wakeup key, and the obtained second temporary key to the second device.

Based on the instructions being executed individually or collectively by the at least one processor, the electronic device is configured to control to output a screen including a second identifier corresponding to provision of the obtained identification information, the obtained wakeup key, and the obtained second temporary key to the second device.

According to aspect of the disclosure, a method of operating an electronic device includes performing a registration procedure corresponding to obtaining control authority for a first device based on characteristic information about the first device; and transmitting, to a second device, data for obtaining the control authority for the first device.

The characteristic information about the first device comprises at least one of identification information of the first device, a first temporary key having a validity time, or a wakeup key, wherein the data for obtaining the control authority comprises at least one of the identification information of the first device, a second temporary key having a validity time, or the wakeup key, wherein a state of the first device is one of a sleep state, an idle state, or an active state, and wherein the performing the registration procedure further includes: obtaining the identification information of the first device, the first temporary key having a validity time, or the wakeup key; based on being connected to the first device corresponding to the obtained identification information based on the obtained first temporary key, obtaining a session key corresponding to connection authority verification for the first device; and decrypting an encrypted base key received from the first device based on the obtained session key to obtain the base key.

The obtaining the identification information of the first device further includes obtaining at least one of the identification information of the first device, the first temporary key having a validity time, or a wakeup key from an image capturing a first identifier displayed on the first device.

The connecting the first device further comprises: obtaining a first encrypted value by encrypting a first temporary value received from the first device with the obtained first temporary key; and transmitting the obtained first encrypted value to the first device for connection.

The obtaining the session key further includes the session key based on a set algorithm based on being connected to the first device.

The method further includes: obtaining a second temporary value from a beacon message received from the first device in the sleep state; obtaining a second encrypted value by encrypting the obtained second temporary value with the obtained wakeup key; transmitting the obtained second encrypted value to the first device in the sleep state; and receiving first identification information from the first device in response to the first device changing from the sleep state to the idle state.

The method further includes: obtaining a third encrypted value by encrypting a third temporary value received from the first device with the obtained session key; transmitting the obtained third encrypted value to the first device in the idle state; receiving second identification information in response to the first device changing from the idle state to the active state; and remotely controlling the first device based on the received second identification information.

The transmitting authority data to the second device includes: based on receiving a request corresponding to control authority sharing, encrypting information corresponding to a current time with the obtained base key to obtain a second temporary key having a validity time; and controlling the communication circuit to provide the obtained identification information, the obtained wakeup key, and the obtained second temporary key to the second device.

The transmitting the authority data to the second device includes controlling to output a screen including a second identifier corresponding to provision of the obtained identification information, the obtained wakeup key, and the obtained second temporary key to the second device.

According to an aspect of the disclosure, a non-transitory recording medium storing computer-readable instructions, wherein the instructions, based on being executed by at least a portion of at least one processor included in an electronic device, cause the electronic device to perform at least one operation, and wherein the at least one operation includes: performing a registration procedure corresponding to obtaining control authority for a first device based on characteristic information about the first device; and controlling a communication circuit of an electronic device to transmit, to a second device, data for obtaining the control authority for the first device to a second device.

An embodiment of the disclosure and terms used therein are not intended to limit the technical features described in the disclosure to specific embodiments, and should be understood to include various modifications, equivalents, or substitutes of the embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element.

As used herein, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

An embodiment as set forth herein may be implemented as software including one or more instructions that are stored in a storage medium (e.g., the memory 990) readable by a machine (e.g., the electronic device 120). For example, a processor (e.g., the processor 920) of the machine (e.g., the electronic device 120) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The storage medium readable by the machine may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to an embodiment of the disclosure may be included and provided in a computer program product. The computer program products may be traded as commodities between sellers and buyers. The computer program product may be distributed in the form of a machine-readable storage medium (e.g., compact disc read only memory (CD-ROM)), or be distributed (e.g., downloaded or uploaded) online via an application store (e.g., Play Store™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to an embodiment, each component (e.g., a module or a program) of the above-described components may include a single entity or multiple entities. Some of the plurality of entities may be separately disposed in different components. According to an embodiment, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

What is claimed:

1. An electronic device, comprising:
a communication circuit;
memory including one or more storage media storing instructions; and
at least one processor including a processing circuit, wherein based on the instructions being executed individually or collectively by the at least one processor, the electronic device is configured to:
perform a registration procedure corresponding to obtaining control authority for a first device based on characteristic information about the first device, and
control the communication circuit to transmit, to a second device, data for obtaining the control authority for the first device.

2. The electronic device of claim 1, wherein the characteristic information about the first device comprises at least one of identification information of the first device, a first temporary key having a validity time, or a wakeup key,
wherein the data for obtaining the control authority comprises at least one of the identification information of the first device, a second temporary key having a validity time, or the wakeup key, and
wherein a state of the first device is one of a sleep state, an idle state, or an active state.

3. The electronic device of claim 1, wherein based on the instructions being executed individually or collectively by the at least one processor, the electronic device is configured to:
obtain identification information of the first device, a first temporary key having a validity time, or a wakeup key,
based on being connected to the first device corresponding to the obtained identification information based on the obtained first temporary key, obtain a session key corresponding to connection authority verification for the first device, and
decrypt an encrypted base key received from the first device based on the obtained session key to obtain a decrypted base key.

4. The electronic device of claim 1, wherein based on the instructions being executed individually or collectively by the at least one processor, the electronic device is configured to obtain at least one of identification information of the first device, a first temporary key having a validity time, or a wakeup key from an image capturing a first identifier displayed on the first device.

5. The electronic device of claim 2, wherein based on the instructions being executed individually or collectively by the at least one processor, the electronic device is configured to:
obtain a first encrypted value by encrypting a first temporary value received from the first device with the obtained first temporary key, and
control the communication circuit to transmit the obtained first encrypted value to the first device for connection to the first device.

6. The electronic device of claim 3, wherein based on the instructions being executed individually or collectively by the at least one processor, the electronic device is configured to obtain the session key based on a set algorithm based on being connected to the first device.

7. The electronic device of claim 2, wherein based on the instructions being executed individually or collectively by the at least one processor, the electronic device is configured to:
obtain a second temporary value from a beacon message received from the first device in the sleep state,
obtain a second encrypted value by encrypting the obtained second temporary value with the obtained wakeup key,
control the communication circuit to transmit the obtained second encrypted value to the first device in the sleep state, and
control the communication circuit to receive first identification information from the first device in response to the first device changing from the sleep state to the idle state.

8. The electronic device of claim 7, wherein based on the instructions being executed individually or collectively by the at least one processor, the electronic device is configured to:
obtain a third encrypted value by encrypting a third temporary value received from the first device with the obtained session key,
control the communication circuit to transmit the obtained third encrypted value to the first device in the idle state,
control the communication circuit to receive second identification information in response to the first device changing from the idle state to the active state, and
remotely control the first device based on the received second identification information.

9. The electronic device of claim 2, wherein based on the instructions being executed individually or collectively by the at least one processor, the electronic device is configured to:
based on receiving a request corresponding to control authority sharing, encrypt information corresponding to a current time with the obtained base key to obtain the second temporary key having the validity time, and
control the communication circuit to provide the obtained identification information, the obtained wakeup key, and the obtained second temporary key to the second device.

10. The electronic device of claim 9, wherein based on the instructions being executed individually or collectively by the at least one processor, the electronic device is configured to control to output a screen including a second identifier corresponding to provision of the obtained identification information, the obtained wakeup key, and the obtained second temporary key to the second device.

11. A method of operating an electronic device, comprising:
performing a registration procedure corresponding to obtaining control authority for a first device based on characteristic information about the first device; and
transmitting, to a second device, data for obtaining the control authority for the first device.

12. The method of claim 11, wherein the characteristic information about the first device comprises at least one of identification information of the first device, a first temporary key having a validity time, or a wakeup key,
wherein the data for obtaining the control authority comprises at least one of the identification information of the first device, a second temporary key having a validity time, or the wakeup key,
wherein a state of the first device is one of a sleep state, an idle state, or an active state, and
wherein the performing the registration procedure further comprises:
obtaining the identification information of the first device, the first temporary key having the validity time, or the wakeup key;
based on being connected to the first device corresponding to the obtained identification information based on the obtained first temporary key, obtaining a session key corresponding to connection authority verification for the first device; and
decrypting an encrypted base key received from the first device based on the obtained session key to obtain the base key.

13. The method of claim 12, wherein the obtaining the identification information of the first device further comprises obtaining at least one of the identification information of the first device, the first temporary key having the validity time, or a wakeup key from an image capturing a first identifier displayed on the first device.

14. The method of claim 12, wherein obtaining the session key further comprises:
obtaining a first encrypted value by encrypting a first temporary value received from the first device with the obtained first temporary key; and
transmitting the obtained first encrypted value to the first device for connection.

15. The method of claim 11, wherein the obtaining the session key further comprises obtaining the session key based on a set algorithm based on being connected to the first device.

16. The method of claim 12, further comprising:
obtaining a second temporary value from a beacon message received from the first device in the sleep state;
obtaining a second encrypted value by encrypting the obtained second temporary value with the obtained wakeup key;
transmitting the obtained second encrypted value to the first device in the sleep state; and
receiving first identification information from the first device in response to the first device changing from the sleep state to the idle state.

17. The method of claim 16, comprising:
obtaining a third encrypted value by encrypting a third temporary value received from the first device with the obtained session key;
transmitting the obtained third encrypted value to the first device in the idle state;
receiving second identification information in response to the first device changing from the idle state to the active state; and
remotely controlling the first device based on the received second identification information.

18. The method of claim 12, wherein transmitting authority data to the second device comprises:
based on receiving a request corresponding to control authority sharing, encrypting information corresponding to a current time with the obtained base key to obtain the second temporary key having the validity time; and
controlling the communication circuit to provide the obtained identification information, the obtained wakeup key, and the obtained second temporary key to the second device.

19. The method of claim 18, wherein transmitting the authority data to the second device includes controlling to output a screen including a second identifier corresponding to provision of the obtained identification information, the obtained wakeup key, and the obtained second temporary key to the second device.

20. A non-transitory recording medium storing computer-readable instructions, wherein the instructions, based on being executed by at least a portion of at least one processor included in an electronic device, cause the electronic device to perform at least one operation, and wherein the at least one operation comprises:
performing a registration procedure corresponding to obtaining control authority for a first device based on characteristic information about the first device; and
controlling a communication circuit of an electronic device to transmit, to a second device, data for obtaining the control authority for the first device to a second device.
